(19) United States
(12) Patent Application Publication
(10) Pub. No.: US 2010/0245072 A1
(43) Pub. Date: Sep. 30, 2010

(54) SYSTEM AND METHOD FOR PROVIDING REMOTE MONITORING SERVICES

(75) Inventor: Jean Claude Harel, San Jose, CA (US)

Correspondence Address: PERKINS COIE LLP, P.O. BOX 1208, SEATTLE, WA, 98111-1208, US

(73) Assignee: Syclipse Technologies, Inc., San Jose, CA (US)

(21) Appl. No.: 12/480,486

(22) Filed: Jun. 8, 2009

Related U.S. Application Data
(60) Provisional application No. 61/163,427, filed on Mar. 25, 2009.

(51) Int. Cl. B60Q 1/26

(52) U.S. Cl. 340/463

(57) ABSTRACT

Systems and methods for providing remote monitoring services are described here. In one aspect, embodiments of the present disclosure include a method for remotely monitoring a mobile vehicle. The method, which may be embodied on a system, includes detecting an occurrence of a triggering event in or near the mobile vehicle via a surveillance device installed with the mobile vehicle, upon the occurrence of the triggering event, receiving, in real time, data including a live recording of an environment surrounding the mobile vehicle and events occurring therein, tracking, in real time, locations of the mobile vehicle, notifying a service subscriber of the occurrence of the triggering event, and/or billing the service subscriber for subscription of remote monitoring of the mobile vehicle.

### CLAIM OF PRIORITY

This application claims priority to U.S. Patent Application No. 61/163,427 entitled “SYSTEM AND METHOD FOR REMOTE SURVEILLANCE AND APPLICATIONS THEREFOR”, which was filed on Mar. 25, 2009, the contents of which are expressly incorporated by reference herein.

### BACKGROUND

Surveillance devices and systems typically lack user-friendliness and ease of use/installation. In addition, monitoring of information captured by surveillance devices is often an additional burden associated with the decision to install surveillance device. Furthermore, the quality of data captured by surveillance devices often suffer from lack of audio quality or video/image resolution since speed and storage space are competing concerns in the design of surveillance devices.

### BRIEF DESCRIPTION OF THE DRAWINGS

FIG. 1A illustrates a block diagram of surveillance devices coupled to a host server that monitors the surveillance devices over a network and communicates surveillance data to user devices over a network.

FIG. 1B illustrates a diagram showing the communication pathways that exist among the surveillance device, the host server, and the user device.

FIG. 2A depicts a block diagram illustrating the components of a surveillance device.

FIG. 2B depicts diagrammatic representations of examples of the image capture unit in the surveillance device.

FIG. 2C depicts a diagrammatic representation of images captured with the image capture unit in the surveillance device and the combination of which to generate a panoramic view.

FIG. 3A depicts the top side view and the rear view of an example of a surveillance device.

FIG. 3B depicts the front view, bottom view, and side view of an example of a surveillance device.

FIG. 4 depicts a series of screenshots of example user interfaces and icons shown on the display of a surveillance device.

FIG. 5 depicts another example of a surveillance device.

FIG. 6 depicts a diagram of an example of a surveillance device used in a surveillance system for theft-prevention of theft-prone goods.

FIG. 7 depicts a diagram of an example of a surveillance device used in a surveillance system for surveillance and recordation of events inside and outside of a vehicle.

FIG. 8 depicts a diagram of an example of using multiple surveillance devices that triangulate the location of a hazardous event by analyzing the sound generated from the hazardous event.

FIG. 9 depicts a block diagram illustrating the components of the host server that generates surveillance data and tactical response strategies from surveillance recordings.

FIGS. 10A-B illustrate diagrams depicting multiple image frames and how data blocks in the image frames are encoded and transmitted.

FIGS. 11A-C depict flow diagrams illustrating an example process for remote surveillance using surveillance devices networked to a remote processing center and user devices for preview of the recorded information.

FIG. 12 depicts a flow diagram illustrating an example process for capturing and compressing a video recording captured by a surveillance device.

FIG. 13 depicts a flow diagram illustrating an example process for providing subscription services for remotely monitoring a mobile vehicle.

FIG. 14 depicts a flow diagram illustrating an example process for providing subscription services for remotely monitoring stationary assets.

FIG. 15 depicts a flow diagram illustrating an example process for providing subscription services for remotely providing travel guidance.

FIGS. 16-17 depict flow diagrams illustrating an example process for protecting data security and optimizing bandwidth for transmission of video frames.

FIG. 18 depicts a flow diagram illustrating an example process for protecting data security and optimizing bandwidth for transmission of data blocks in a data file.

FIGS. 19-20 depict flow diagrams illustrating another example process for optimizing bandwidth for transmission of data blocks in a data file.

FIG. 21 depicts a flow diagram illustrating an example process for optimizing bandwidth for streaming video over a network.

FIG. 22 shows a diagrammatic representation of a machine in the example form of a computer system or computing device within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for providing remote monitoring services.

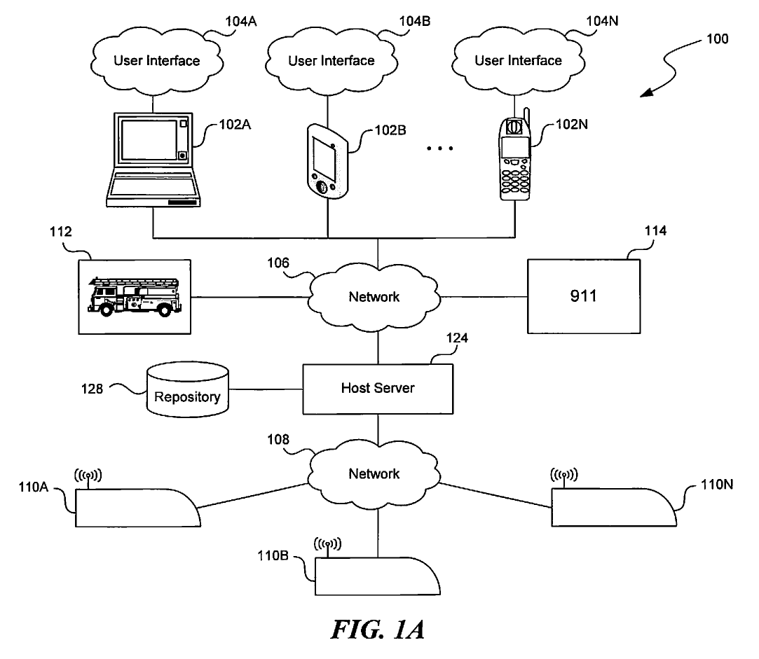

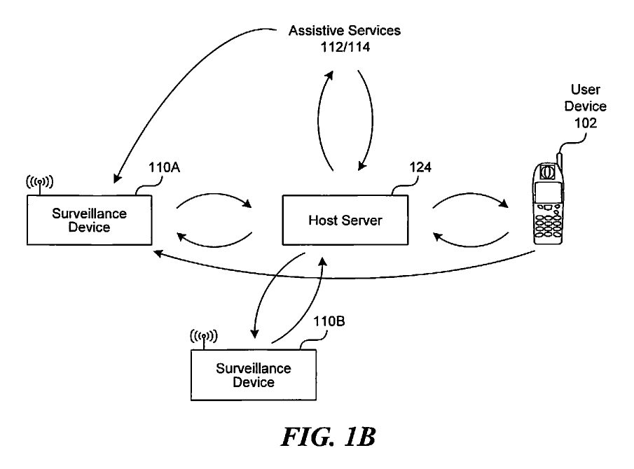

FIG. 1A illustrates a block diagram of surveillance devices 110A-N coupled to a host server 124 that monitors the surveillance devices 110A-N over a network 108 and communicates surveillance data to user devices 102A-N over a network 106, according to one embodiment.

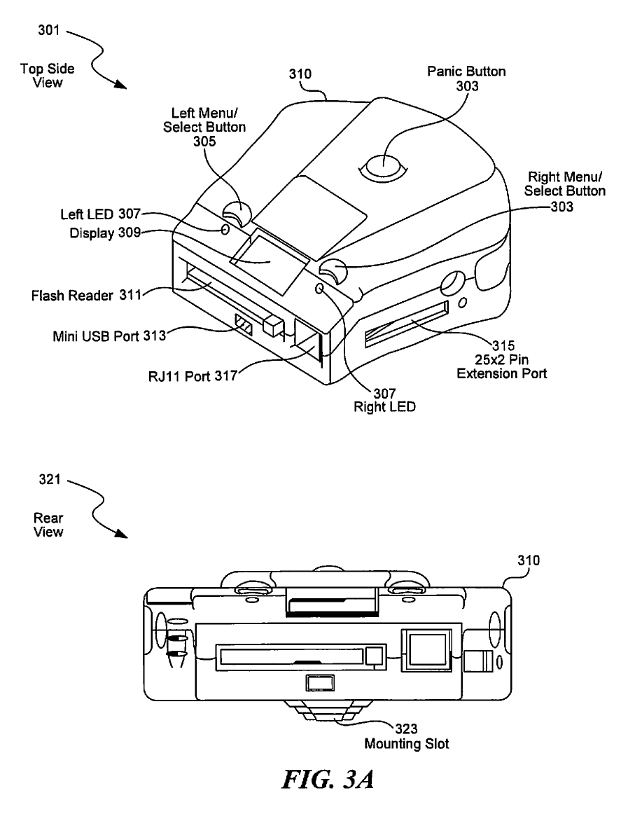

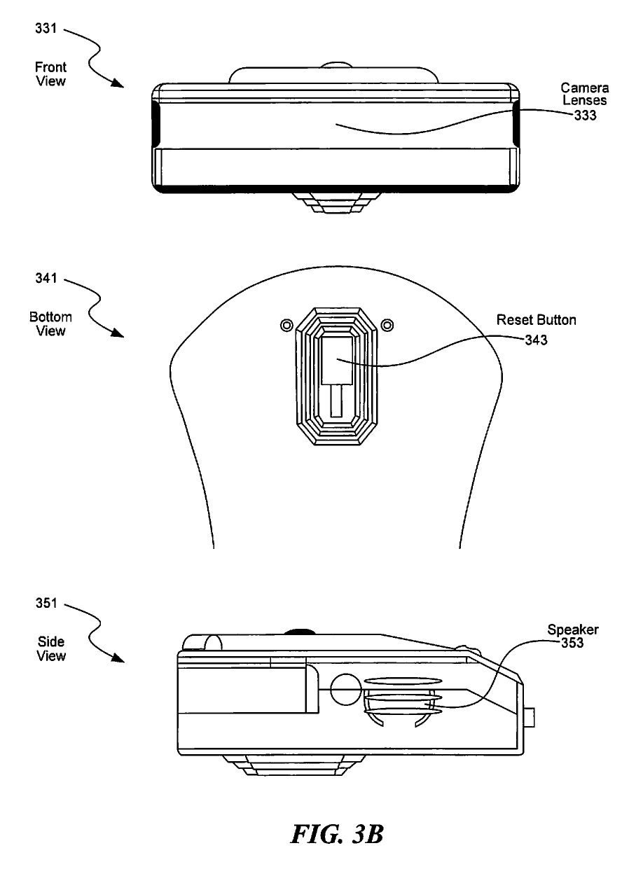

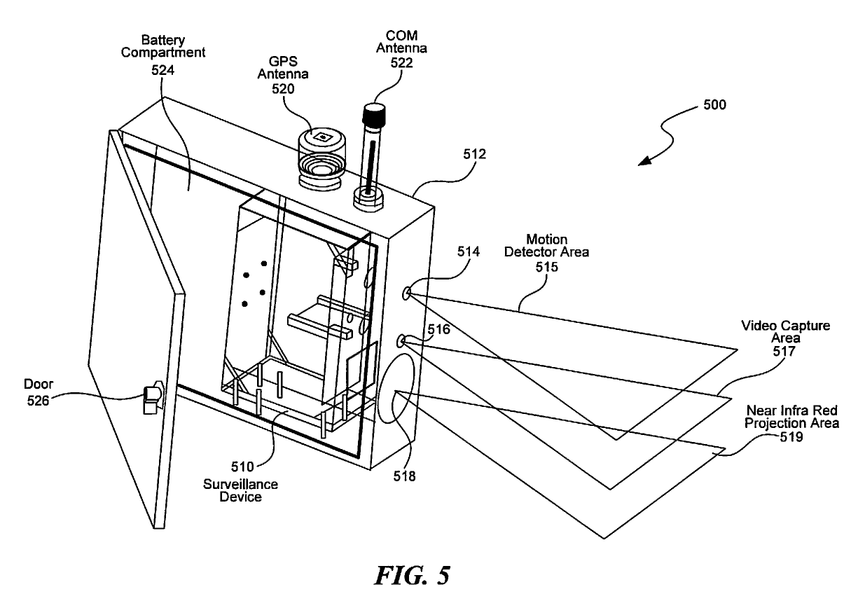

The surveillance devices 110A-N can be any system, device, and/or any combination of devices/systems that is able to capture recordings of its surrounding environment and/or the events occurring in the surrounding environment and/or nearby areas. In general, the surveillance device 110 is portable such that each unit can be installed or uninstalled and moved to another location for use by a human without assistance from others or a vehicle. In addition, the surveillance device 110 generally has a form factor that facilitates ease of portability, installation, un-installation, deployment, and/or redeployment. In one embodiment, each surveillance device has dimensions of approximately 68×135×40 mm³. Some examples of the various form factors of the surveillance devices 110A-N are illustrated with further reference to the examples and description of FIG. 3 and FIG. 5. The surveillance devices 110A-N can operate wired or wirelessly. For example, the surveillance device 110A-N can operate from batteries, when connected to another device (e.g., a computer) via a USB connector, and/or when plugged in to an electrical outlet.

In one embodiment, the surveillance device 110A-N includes a USB port which can be used for, one or more of, powering the device, streaming audio or video, and/or file transfer. The surveillance device 110A-N can also include an RJ11 port and/or a vehicle power port adaptor.

The surveillance devices 110A-N may be able to connect/communicate with one another, a server, and/or other systems. The surveillance devices 110A-N can communicate with one another over the network 106 or 108, for example, to exchange data including video, audio, GPS data, instructions, etc. For example, images, audio, and/or video captured or recorded via one surveillance device can be transmitted to another. This transmission can occur directly or via server 124.

The surveillance devices 110A-N can include a capture unit with image, video, and/or audio capture capabilities. Note that the surveillance devices also include audio playback capabilities. For example, the audio recorded by the surveillance device may be played back. In addition the recorded audio may be sent to another surveillance device for playback. In addition, the surveillance devices 110A-N may be location aware. For example, the surveillance devices 110A-N may include, internally, a location sensor. Alternatively, the surveillance devices 110A-N may obtain location data from an external agent or service.

One embodiment of the surveillance device 110A-N further includes a flash reader (e.g., flash reader 311 in the example of FIG. 3A). The flash reader may be suitable for reading any type of flash memory cards including but not limited to MultiMedia Card, Secure Digital, Memory Stick, xD-Picture card, Compact Flash, RS-MMC, Intelligent Stick, miniSD, and/or microSD.

In one embodiment, the surveillance devices 110A-N communicate with the host server 124 via network 108. The surveillance devices 110A-N can upload, automatically, manually, and/or automatically in response to a triggering event, recorded data to the host server 124 for additional processing and monitoring, with a delay or in real time/near real time. The recorded data that is uploaded can be raw data can further include processed data. The recorded data can include images, a video recording and/or an audio recording of the environment surrounding the surveillance devices 110A-N and the nearby events. In addition, the recorded data can include location data associated with the video/audio recording. For example, a location map of the recorded data can be generated and provided to other devices or systems (e.g., the host server 124 and/or the user devices 102A-N).

In some embodiments, the surveillance devices 110A-N encode and/or encrypt the recorded data. The recorded data can be stored on the local storage unit of the surveillance devices 110A-N in the original recorded format or in encoded form (compressed) to decrease file size. In addition, the recorded data can be encrypted and stored in local storage in encrypted form to prevent unauthorized access of the recorded data.

The surveillance devices 110A-N may be placed indoors or outdoors in a mobile and/or still unit. For example, the surveillance devices 110A-N can be placed among or in the vicinity of theft-prone goods for theft prevention and event monitoring. The surveillance devices 110A-N can also be placed in vehicles to monitor and create a recordation of events occurring inside and outside of the vehicle. The surveillance devices 110A-N may upload or transmit the recordation of events and their associated location data to a processing center such as the host server 124.

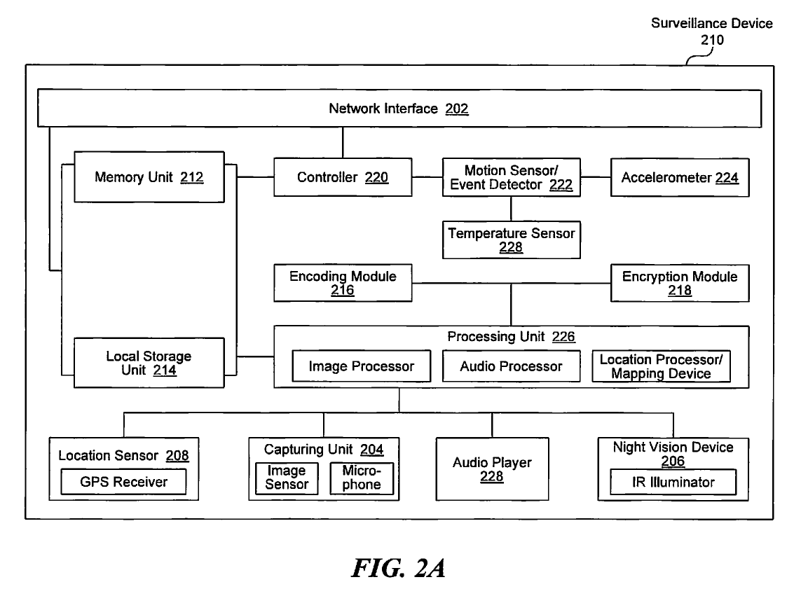

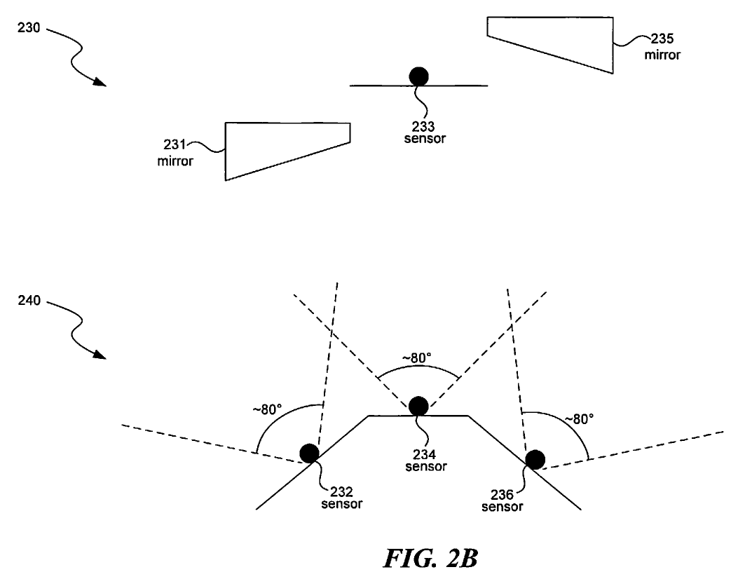

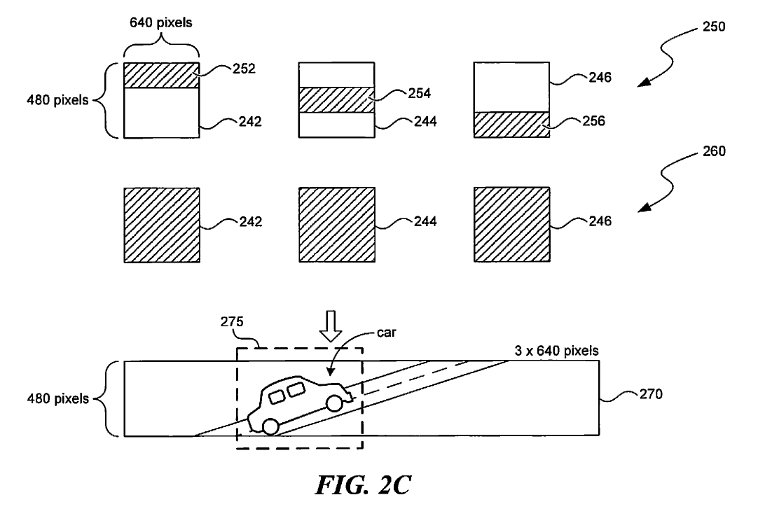

Although multiple surveillance devices 110A-N are illustrated, any number of surveillance devices 110A-N may be deployed in a given location for surveillance monitoring. Additional components and details of associated functionalities of the surveillance devices 110A-N are described with further reference to the example of FIGS. 2-3 and FIG. 5.

The user devices 102A-N can be any system and/or device, and/or any combination of devices/systems that is able to establish a connection with another device, a server and/or other systems. The client devices or user devices 102A-N typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile or portable phone, a smart phone, a PDA, a Blackberry device, a Treo, and/or an iPhone, etc. In one embodiment, client devices or user devices 102A-N are coupled to a network 106. In some embodiments, the devices 102A-N may be directly connected to one another.

The user devices 102A-N can communicate with the host server 124, for example, through network 106 to review surveillance data (e.g., raw or processed data) gathered from the surveillance devices 110A-N. The surveillance data can be broadcasted by the host server 124 to multiple user devices 102A-N which can be operated by assistive services, such as 911 emergency services 114, fire department 112, medical agencies/providers, and/or other law enforcement agencies. The broadcasted surveillance data may be further processed by the host server 124 or can include the raw data uploaded by the surveillance devices.

In one embodiment, the host server 124 processes the information uploaded by the surveillance devices 110A-N and generates a strategic response using the uploaded information including live recordings captured by the surveillance devices 110A-N. For example, the strategic response can include determination of hazardous locations, hazardous events, etc. The strategic response can then be broadcast along with surveillance data to user devices 102A-N for use by authorities or law enforcement individuals in deployment of emergency response services.

The networks 106 and 108, over which user devices 102A-N, the host server 124, and surveillance devices 110A-N communicate, may be a telephonic network, a cellular network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 and 108 can be any collection of distinct networks operating wholly or partially in conjunction to provide connectivity to the user devices 102A-N, host server 124, and/or surveillance devices 110A-N and may appear as one or more networks to the serviced systems and devices. In one embodiment, communications to and from user devices 102A-N can be achieved by, a cellular network, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), a wireless telephone network, a VoIP network, a cellular network, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless voice/data networks or messaging protocols.

The repository 128 can store software, descriptive data, images, system information, drivers, and/or any other data item utilized by other components of the host server 124, the surveillance devices 110A-N and/or any other servers for operation. The repository 128 may be coupled to the host server 124. The repository 128 may be managed by a database management system (DBMS), for example but not limited to, Oracle, DB2, Microsoft Access, Microsoft SQL Server, PostgreSQL, MySQL, FileMaker, etc.

The repository 128 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 124 is able to provide data to be stored in the repository 128 and/or can retrieve data stored in the repository 128.The repository 128 can store surveillance data including raw or processed data including live and/or archived recordings captured by the surveillance devices 110A-N. The repository 128 can also store any information (e.g., strategic response, tactical response strategies) generated by the host server 124 accompanying the recorded data uploaded by the surveillance devices 110A-N. In some embodiments, the repository 128 can also store data related to the surveillance devices 110A-N including, the locations where they are deployed, the application for which they are deployed, operating mode, the hardware model, firmware version, software version, last update, hardware ID, date of manufacture, etc.

FIG. 1B illustrates a diagram showing the communication pathways that exist among the surveillance devices 110A-B, the host server 124, the user device 102, and assistive services 112 and 114, according to one embodiment.

In one embodiment, the surveillance devices 110A-B are operable to capture recordings and to upload or transmit such recordings and/or any additionally generated data/enhancements or modifications of the recordings to the host server 124. The recordings may be uploaded to the host server 124 automatically (e.g., upon detection of a trigger or an event) or upon request by another entity (e.g., the host server 124, the user device 102, and/or assistive services 112/114), in real time, near real time, or after a delay.

The host server 124 can communicate with the surveillance devices 110A-B as well. The host server 124 and the surveillance devices 110A-B can communicate over a network including but not limited to, a wired or wireless network over the Internet or a cellular network. For example, the host server 124 may send a request for information to the surveillance devices 110A-B. In addition, the host server 124 can remotely upgrade software and/or firmware of the surveillance devices 110A-B and remotely identify the surveillance devices that should be affected by the upgrade.

In one embodiment, when connected to the cellular network, the surveillance devices 110A-B are operable to receive Short Message Services (SMS) messages and/or other types of messages, for example, from the host server 124. For example, SMS messages can be sent from the host server 124 to the surveillance devices 110A-B. The SMS messages can be a mechanism through which the host server 124 communicates with users of the surveillance device 110A-B. For example, received SMS messages can be displayed on the surveillance device 110A-B. In addition, the SMS messages can include instructions requesting the surveillance device 110A-B to perform a firmware or software upgrade. Upon receiving such messages, the surveillance device 110A-B can establish a communication session with the server 124 and login to perform the upgrade.

In one embodiment, the surveillance devices 110A-B can receive audio and/or voice data from the host server 124. In addition, the host 124 can send voicemails to the devices 110A-B for future playback. The audio and/or voice data can include turn-by-turn directions, GPS information, mp3 files, etc.

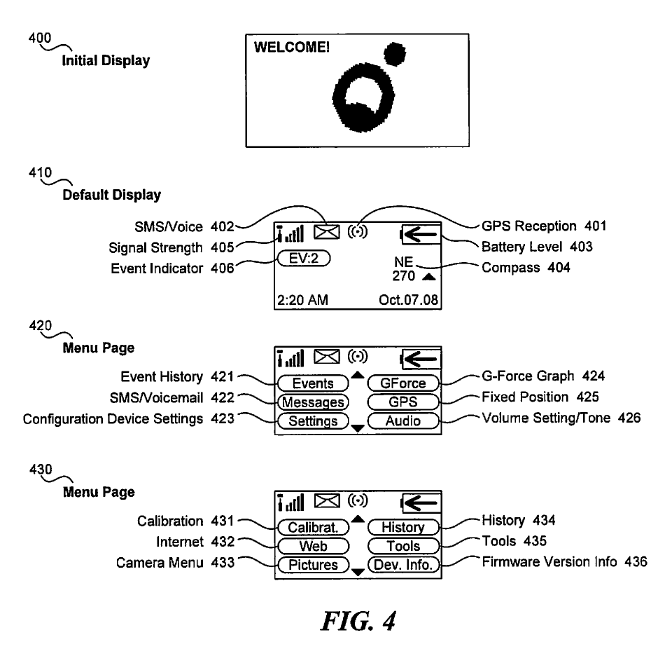

Note that in some instances, the surveillance device 110A-N includes a display unit. The display unit can be used to navigate through messages or voicemails received by the surveillance device 110A-N. The display unit and some example screenshots are illustrated with further reference to FIGS. 3-4. The display unit may be an LED or an OLED display and can further display touch-screen sensitive menu buttons for facilitate navigation through content or the various functions provided by the surveillance device 110A-N.

The host server 124 can also communicate with a user device 102. The user device 102 may be an authorized device or may be operated by an authorized user or authorized assistive services 112/114. The host server 124 can broadcast the recordings captured by the surveillance devices 110A-B to one or more user devices 102. These recordings may be further enhanced or processed by the host server 124 prior to broadcast. In addition, the host server 124 can retrieve or generate supplemental information to be provided the recordings broadcast to the user device 102.

The user device 102 can communicate with the host server 124, for example, over a wired or wireless network such as the Internet or cellular network. In one embodiment, the user device 102 sends SMS messages and/or voicemail messages to the surveillance device 110A-B over the cellular network. The user device 102 can be used (e.g., operated by a law enforcement individual, security services, or emergency services provider) to request information including recordings (e.g., live recordings) of events from the host server 124. The user device 102 can also be used to request to download certain modified or enhanced information generated by the host server 124 based on surveillance data uploaded by the surveillance devices 110A-B.

The user device 102 can communicate with the surveillance devices 110A-B through the host server 124. For example, the user device 102 can be used to configure or adjust one or more operations or operating states of the surveillance devices 110A-B. For example, the user device 102 can be used to trigger or abort the upload of the recording by the surveillance devices 110A-B to the remote server 124. In addition, the user device 102 can be used to trigger broadcast of the at least a portion of the recording by the remote server 124 to the user device 102 or multiple user devices. In some embodiments, the user device 102 can control orientations/position of cameras or other imaging devices in the surveillance devices 110A-B to adjust a viewpoint of a video recording, for example.

The host server 124 can communicate with assistive services 112/114 including emergency services, emergency health services, or law enforcement authority. The host server 124 can broadcast recordings from the surveillance devices 110A-B to the assistive services 112/114. The recordings allow assistive services 112/114 to obtain real time images/audio of the events occurring in an emergency or crisis situation to allow them to develop crisis resolution strategies. In addition, the host server 124 can generate a tactical response to be broadcasted to the assistive services 112/114 or any associated devices.

Assistive services 112/114, using their associated devices, can communicate with the host server 124. For example, assistive services 112/114 can request the host server 124 to broadcast or send specific recordings from a particular event that may be still occurring or that has occurred in the past. In addition, assistive services 112/114 can communicate with the surveillance devices 110A-B directly through a network or via the host server 124. Assistive services 112/114, by communicating with surveillance devices 110A-B, may be able to control their operation or operational state. For example, assistive services 112/114, may request that the surveillance devices 110A-B begin or abort upload of recordings. Assistive services 112/114 may also, through a network, adjust various hardware settings of the surveillance devices 110A-B to adjust characteristics of the recorded audio and/or video data.

FIG. 2 depicts a block diagram illustrating the components of a surveillance device 210, according to one embodiment.

The surveillance device 210 includes a network interface 202, a capturing unit 204, a night vision device 206, a location sensor 208, a memory unit 212, a local storage unit 214, an encoding module 216, an encryption module 218, a controller 220, a motion sensor/event detector 222, an accelerometer 224, and/or a processing unit 226.

The memory unit 212 and local storage unit 214 are, in some embodiments, coupled to the processing unit 226. The memory unit 212 can include volatile and/or non-volatile memory including but not limited to SRAM, DRAM, MRAM, NVRAM, ZRAM, TTRAM, EPROM, EEPROM, solid-state drives, and/or Flash memory. The storage unit 214 can include by way of example but not limitation, a hard disk drive, an optical disk drive, etc.

Additional or less modules can be included without deviating from the novel art of this disclosure. In addition, each module in the example of FIG. 2 can include any number and combination of sub-modules, and systems, implemented with any combination of hardware and/or software modules.

The surveillance device 210, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 2, the network interface 202 can be a networking device that enables the surveillance device 210 to mediate data in a network with an entity that is external to the host server, through any known and/or convenient communications protocol supported by the host and the external entity. The network interface 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

One embodiment of the surveillance device 210 includes a capturing unit 204. The capturing unit 204 can be any combination of software agents and/or hardware modules able to capture, modify, analyze, a recording of surrounding environment, settings, objects, and/or events occurring in the environment surrounding the surveillance device.

The capturing unit 204, when in operation, is able to capture a recording of surrounding environments and events occurring therein. The captured recording can include audio data and/or video data of the surrounding environment that can be stored locally, for example in the local storage unit 214. The recording can include video data that is live. In addition, the recording can include live audio data of the surrounding environment and occurring events that are synchronized to the live video data. In one embodiment, the live video data includes a colored panoramic view of the surrounding environment and the events occurring therein and in nearby areas.

The live video and/or audio data can be uploaded, in real time or near real time as the recording is occurring, to another location or entity (e.g., the host server 124 and/or user device 102 of FIGS. 1A-B). In one embodiment, the capturing unit 204 includes at least one camera sensor or at least one imaging device including but not limited to, cameras, camera sensors, CMOS sensors, CCD sensors, photodiode arrays, and/or photodiodes, etc. The capturing unit 204 can include a single imaging device or multiple imaging devices comprised of the same types of sensors or a combination of different types of sensors.

Each sensor, camera, or imaging device can be controlled independently of others or dependently on others. Note that imaging settings of individual imaging devices (e.g., orientation, resolution, color scale, sharpness, frame rate, etc.) may be manually configured/adjusted or remotely configured/adjusted before, during, or after deployment. For example, imaging settings may be configured/adjusted via command issued through a backend server/processing center (e.g., the host server 124 of FIGS. 1A-B).

In one embodiment, the frame rate of each camera sensor/imaging device is generally between 0.1-40 frames/second or more usually between 0.2-35 frames/second. The frame rate of each individual sensor is generally individually adjustable manually or automatically adjusted based on lighting conditions. The frame rate is generally automatically configured or selected for performance optimization in capturing images and videos.

One embodiment of the capturing unit 204 includes another camera sensor. The additional camera sensor is generally configured to operate at a lower frame rate than the other camera sensors. The lower-frame rate camera sensor can be positioned on or near the surveillance device 210 for imaging scenery that is not frequently updated (e.g., the inside of a mobile vehicle).

Note that the camera and/or sensors in the capturing unit 204 can be configured and oriented such that a wide angle view can be captured. In one embodiment, the viewing angle of the captured image/video includes a panoramic view of the surrounding environment that is approximately or greater than 150 degrees. In one embodiment, the viewing angle that can be captured is approximately or greater than 180-200 degrees. One embodiment includes multiple cameras/sensors arranged so that at approximately a field of view of 240 degrees can be imaged and captured.

For example, the surveillance device 210 can include three cameras/sensors, four cameras/sensors, five cameras/sensors, or more. Each camera sensor can, for example, capture a field of view of approximately 50-90 degrees but more generally 60-80 degrees. The pitch of the field of view can be approximately 40-75 degrees or more generally 50-65 degrees. One of the camera/sensor is arranged or configured to monitor a frontal view and two side cameras can be arranged/configure to monitor side views.

In general, each of the at least one camera sensors are configured to capture adjacent fields-of-views that are substantially non-overlapping in space to yield, for example, when the capturing unit 204 includes three camera sensors, a cumulative field of view of 150-270 degrees or 180-240 degrees can be obtained. In FIG. 2B, an example configuration of three camera sensors used to capture of field of view of approximately 240 degrees is illustrated (configuration 240). Note that the pitch of the cumulative field of view including three camera sensors can be approximately 10-30 degrees but more generally between 15-25 degrees.

In one embodiment, some sensors are replaced by or used in conjunction with optically coupled mirrors to image regions that would otherwise be out of the field of view. In FIG. 2B, an example configuration of a camera sensor used with optically coupled mirrors is depicted (configuration 230).

Examples of images captured with the imaging device(s) are illustrated with further reference to the example of FIG. 2C.

One embodiment of the surveillance device 210 includes a night vision device 206. The capturing unit 204 can be any combination of software agents and/or hardware modules including optical instruments that allow image or video capture in low lighting or low vision levels.

The capturing unit 204 can be coupled to the night vision device 206 such that during night time or other low visibility situations (e.g., rain or fog), images/videos with objects that are visible or distinguishable in the surrounding environment can still be captured. The capturing unit 204 can include lighting devices such as an IR illuminator or an LED to assist in providing the lighting in a low-vision environment such as at night or in the fog such that images or videos with visible objects or people can be captured.

One embodiment of the capturing unit 204 includes one or more microphones. The microphones can be used for capturing audio data. The audio data may be sounds occurring in the environment for which images and/or videos are also being captured. The audio data may also include recordings of speech of users near the surveillance device 210. The user can use the microphone in the capturing unit 204 to record speech including their account of the occurring events, instructions, and/or any other type of information.

The recorded audio can be stored in memory or storage. In addition, the recorded audio can be streamed in real time or with a delay to the host server or another surveillance device for playback. For example, audio recordings of instructions or other types of information recorded by users at the scene can be broadcast to other users via surveillance devices to inform or warn them of the local situation. The audio recording can also be stored and sent to the host server or a user device as a file for downloading, storage, and/or subsequent playback.

In one embodiment, the surveillance device 210 includes an audio code to compress recorded audio, for example, into one or more digital audio formats including but not limited to MP3. The audio codec may also decompress audio for playback, for example, via an internal audio player. The audio may be received over a network connection or stored in local storage or removable storage. For example, the audio can include audio streamed or downloaded from other surveillance devices or the host server. In one embodiment, audio is transmitted between surveillance devices and between surveillance devices/host servers via VoIP. The audio can also include audio files stored on media coupled to or in the surveillance device.

One embodiment of the surveillance device 210 includes an audio player 228. The audio player 228 can include any combination of software agents and/or hardware modules able to perform playback of audio data including recorded audio, audio files stored on media, streaming audio, downloaded audio, in analog or digital form. The audio player 228 can include or be coupled to a speaker internal to or coupled to the surveillance device 210, for example.

For example, the audio player 228 can perform playback of audio files (e.g., MP3 files or other types of compressed digital audio files) stored in local storage or on external media (e.g., flash media inserted into the surveillance device). The audio player 228 can also perform playback of audio that is streaming live from other surveillance devices or the host server or other types of client devices (e.g., cell phone, computer, etc.). Additionally, the audio player 228 can playback music files downloaded from another device (e.g., another surveillance device, computer, cell phone, and/or a server).

One embodiment of the surveillance device 210 includes a location sensor 208. The location sensor 208 can be any combination of software agents and/or hardware modules able to identify, detect, transmit, compute, a current location, a previous location, a range of locations, a location at or in a certain time period, and/or a relative location of the surveillance device 210 or objects and people in the field of view of the surveillance device 210.

The location sensor 208 can include a local sensor or a connection to an external agent to determine the location information. The location sensor 208 can determine location or relative location of the surveillance device 210 via any known or convenient manner including but not limited to, GPS, cell phone tower triangulation, mesh network triangulation, relative distance from another location or device, RF signals, RF fields, optical range finders or grids, etc. One embodiment of the location sensor includes a GPS receiver. For example, the location-sensor can perform GPS satellite tracking and/or cell-tower GPS tracking.

In one embodiment, the location sensor 208 determines location data or a set of location data of the surveillance device 210. The location data can thus be associated with a captured recording of the surrounding environment. For example, the location data of the places in the captured image/video can automatically be determined and stored with the captured recording in the local storage unit 214 of the surveillance device 210. If the surveillance device 210 is in motion (e.g., if the surveillance device is installed or placed in/on a mobile unit), then the location data includes multiple locations associated with locations of the surveillance device 210. The recording of the surrounding environment and events that are captured by the surveillance device 210 in motion can therefore have location data with multiple sets of associated locations.

For example, each frame of the video/audio recording can be associated with different location data (e.g., GPS coordinates) such that a reviewer of the recording can determine the approximate or exact location where the objects, people, and/or events in the recording occurred or is currently occurring. The location data can be presented as text overlaid with the recorded video during playback. The location data can be presented graphically or textually in a window that is separate from the video playback window.

In one embodiment, the images or videos are recorded in high resolution by the surveillance device 210 and compressed before transmission over the network. The compression ratio can be anywhere between 15-95%. To optimize bandwidth required of transmission, the compression ratio can be anywhere between 80-95%. In addition, the images, videos and/or audio data can be downloaded as a file from the surveillance device 210.

The data captured by the capturing unit 204 and detected from the location sensor 208 can be input to a processing unit 226. The processing unit 226 can include one or more processors, CPUs, microcontrollers, FPGAs, ASICs, DSPs, or any combination of the above. Data that is input to the capturing unit 204 can be processed by the processing unit 204 and output via a wired or wireless connection to an external computer, such as a host or server computer by way of the network interface 202.

The processing unit 226 can include an image processor, an audio processor, and/or a location processor/mapping device. The processing unit 226 can analyze a captured image/video to detect objects or faces for identifying objects and people of interest (e.g., via object recognition or feature detection), depending on the specific surveillance application and the environment in which the surveillance device 210 is deployed. These objects may be highlighted in the video when upload to the backend server. Detection of certain objects or objects that satisfy certain criteria can also trigger upload of recorded data to the backend server/processing center for further review such that further action may be taken.

The processing unit 226, in one embodiment, performs audio signal processing (e.g., digital signal processing) on captured audio of the surrounding environments and the nearby events. For example, frequency analysis can be performed on the captured audio. In addition, the processing unit 226, using the location data provided by the location sensor 208, can determine the location or approximate location of the source of the sound. In one embodiment, using the audio data captured using multiple surveillance devices 210, the location of the source of the sound can be determined via triangulation.

One embodiment of the surveillance device 210 includes an encoding module 216. The encoding module 216 can include any combination of software agents and/or hardware modules able to convert the recording and any additional information from one format to another. The encoding module 216 can include a circuit, a transducer, a computer program, and/or any combination of the above. Format conversion can be performed for purposes of speed of transmission and/or to optimize storage space by decreasing the demand on storage capacity of a given recording.

In one embodiment, the encoding module 216 compresses data (e.g., images, video, audio, etc.) recorded by the surveillance device 210. The data can then be stored in compressed form or partially compressed form in memory 212 or local storage 214 to conserve storage space. In addition, the compressed data by be transmitted or uploaded to the remote server from the surveillance device 210 to conserve transmission bandwidth thus increasing the upload speed.

In one embodiment, the recording captured by the surveillance device 210 is compressed to a lower resolution to be streamed wirelessly in real time to a remote computer or server over the network connection. The recording can be stored at a higher resolution in the storage unit. In addition, the recording can be transferred wirelessly as a file to the remote computer or server or other surveillance devices, for example.

In one embodiment, the recorded video is encoded using Motion JPEG (M-JPEG). The recorded video can generally be captured, by the surveillance device 210, at an adjustable rate of between 0.2 to 35 frames per second, depending on the application. The frame rate can be determined automatically for each camera/sensor, for example, based on lighting conditions to optimize the captured image/video. The frame rate can also be manually configured by a user.

The compression ratio for Motion JPEG recording is also automatically adjusted, for example, based on original file size and target file size. The target file size may depend on available storage space in the surveillance device 210. The compression ratio can also be determined in part by network capacity.

The encoding module 216 can be coupled to the processing unit 226 such that captured images, videos, audio, modified data, and/or generated text can be compressed, for example, for transmission or storage purposes. The compression can occur prior to storage and/or upload to the remote server. Note that in the local storage unit 214, recorded data may be stored in storage 214 encoded form or un-encoded form.

In one embodiment, the encoding module 216 computes the check sum (or, a signature value) of data blocks in a data file (e.g., a text file, an audio file, an image, a frame of video, etc.). The check sum of each data block of a data file can be computed and used in determining which data blocks are to be transmitted or uploaded to a remote processing center or host server. In general, the check sum of each data block can be computed at various time intervals and when the check sum value of a particular data block differs at a later time as compared to an earlier time, then the data blocks is transmitted to the remote unit such that the data file can be reconstituted remotely.

In addition, checksums of each data block in a data file can be compared with one another. For each data block where the check sum values are equal, only one of the data blocks is sent to the host server since data blocks have the same check sums, the corresponding content is generally the same. The host server, upon receiving the data block can replicate the contents thereof at multiple locations in the data file where applicable (e.g., at the other data blocks having the same checksum value). Thus, the required bandwidth for data transmission or streaming can be optimized since duplicated data blocks across a particular data file is not transmitted redundantly. Furthermore, data blocks that do not change in content over time is also not transmitted redundantly.

In one embodiment, the encoding module computes the checksum value (e.g., unique signature) of a data block. The checksum value of the data block can further be stored, for example in a machine readable storage medium (e.g., local storage or memory in the surveillance device or other storage mediums on other types of machines and computers). The data block can be initially transmitted or otherwise uploaded to a remote server without. For example, data blocks in a data file for which no version has been sent to the remote server, can be initially sent without checksum comparison. However, checksums of data blocks in the data file can be compared with one another such only data blocks with unique checksums are sent.

At a subsequent time, an updated checksum value can be computed for an updated data block. The updated checksum value can be compared with the checksum value stored in the computer-readable storage medium. If the updated checksum value is not equal to the checksum value, the updated data block can be transmitted to the remote server.

The process can be repeated for each data block in the data file. For example, a set of checksum values can be computed for multiple data blocks at multiple locations in a data file. In general though not necessarily, each of the data blocks corresponds to non-overlapping data locations in the data file. At a subsequent time, the encoding module 216 can compute the updated set of checksum values for each of the multiple data blocks. Each of the updated set of checksum values can be compared with each of the first set of checksum values to identify blocks that have updated content.

Using the comparison, the encoding module 216 can identify updated data blocks from the multiple data blocks. The updated data blocks are generally detected from data blocks that have an updated checksum value that does not equal each of the corresponding checksums of the first set of checksum values.

In one embodiment, each the updated data blocks are transmitted to the remote server where the data file can be reconstituted. The server can, for example, update the data file using the updated data blocks.

Alternatively, the encoding module 216 can compare checksums of each of the updated data blocks to one another. Based on the comparison, the encoding module 216 can, for example, identify the unique data blocks from the updated data blocks. For example, if checksums of data block #3 and data block #25 are both changed from previous values but are updated to the same value, only one of the updated block #3 and block #25 needs to be transmitted to the remote server. Thus, each of the unique data blocks can be transmitted to the remote server.

For the remote server to know where the unique data blocks are to be used, a message identifying the locations where the data blocks are used can be generated can sent to the remote server along with the data blocks. For example, the encoding module 216 identifies the locations in the data file where the unique data blocks are to be applied by the remote server and generates a message containing such information. The message identifying the set of locations can then be transmitted to the remote server.

For example, a short message can be generated by the surveillance device 210 to include the contents of a data block and the positions in the data file where the content is to be re-used or duplicated at the recipient end. The short message can include the content of multiple data blocks and their associated positions. In general, the short message is sent to the remote server when the buffer is full or timed out.

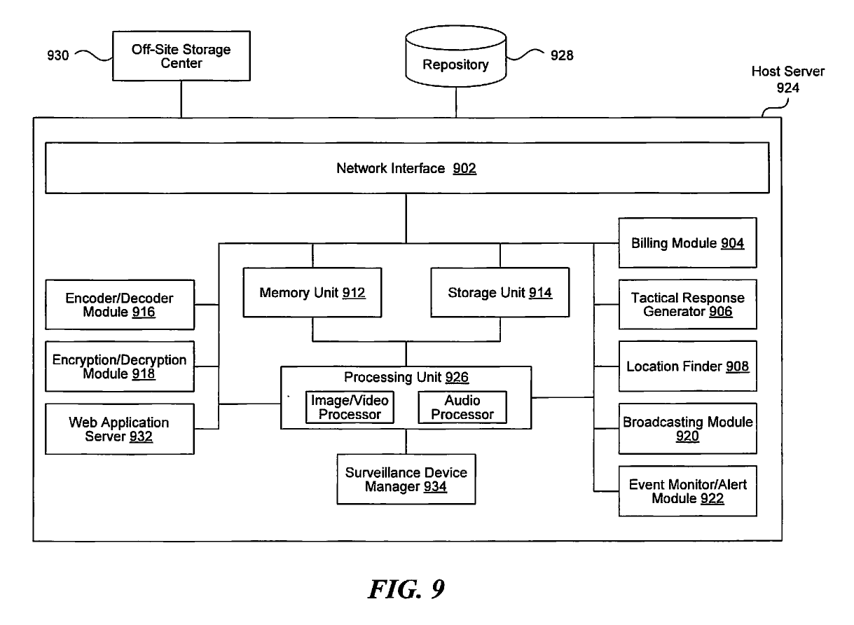

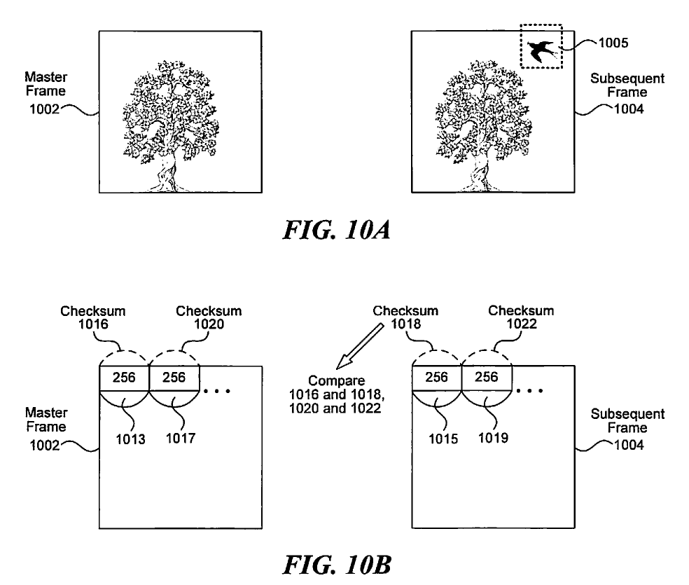

The remote server upon receiving the data blocks and the message can perform a set of processes to reconstitute the data file. This process is described with further reference to the example of FIG. 9. Graphical depictions of the encoding process and the checksum comparison process are illustrated with further reference to the example of FIGS. 10A-10B.

The data files whose transmission can be optimized using checksum computation and comparison include any type of data files (e.g., audio, video, text, etc.). In one embodiment the data files are audio files or text files. The audio may be generated or recorded locally at the device (e.g., the surveillance device 210 or any other devices with sound generating or sound capturing capabilities).

In one embodiment, the data file is a video and the data blocks correspond to data locations in a video frame of the video. The video can be captured by the surveillance device 210 or any other connected or networked devices. The video can also be retrieved from local storage (e.g., memory or storage unit). Each of the first set of data blocks of a video frame can be streamed to the remote server if the video frame is the first of a series of video frames. The data blocks in the video frame generally correspond to non-overlapping pixel locations in the video frame. To optimize bandwidth when streaming video, checksums of the data blocks in a video frame and subsequent video frames can be computed by the encoding module 216 to determine which data blocks are streamed.

Note that in one embodiment, the video and its frames to be streamed can be captured by the surveillance device 210 and can include recording of environment surrounding the surveillance device and events occurring therein (e.g., live or delayed). In some embodiments, the video and its frames can be captured by other devices. In one embodiment, the video including the video frames are MPEG4 encoded (e.g., MPEG4-AVC) and the checksum values can be although not necessarily computed from MPEG4 encoded data frames.

In some instances, the data files (e.g., the video and its frames) to be transmitted to the remote server are encrypted. The checksum values for the data files and subsequent versions can be computed after the encryption (on the encrypted version) or before the encryption (on the un-encrypted version).

Note that although the encoding process for bandwidth optimization is described in conjunction with the encoding module 216 in the surveillance device 210, the process can be performed by any device to encode data to optimize bandwidth during data transmission. For example, the encoding process described above can be performed by any general purpose computer, special purpose computer, a sound recording unit, an imaging device (e.g., a video camera, a recorder, a digital camera, etc.).

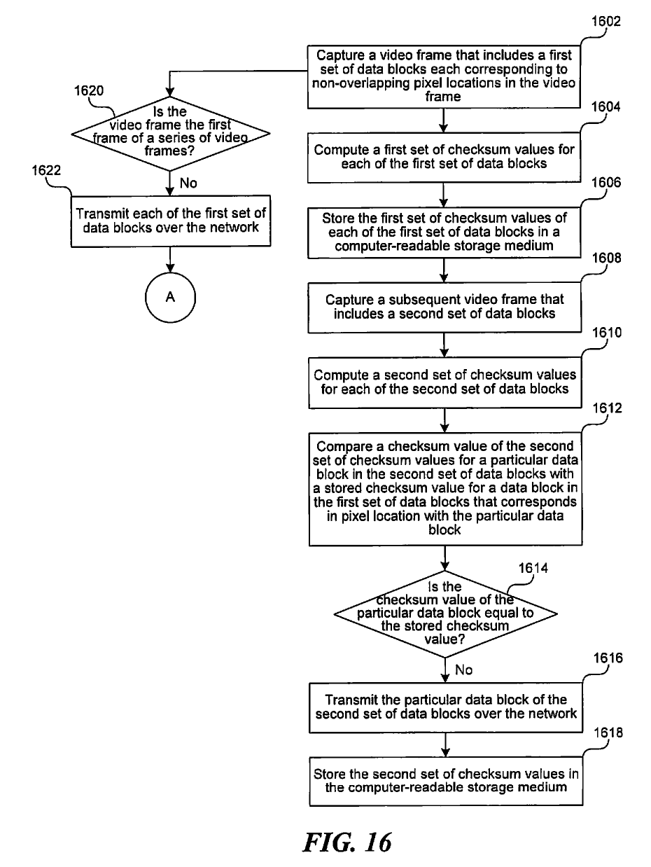

The encoding process for data security and/or bandwidth optimization is further described and illustrated with reference to the examples of FIGS. 10A-B and FIGS. 16-21.

One embodiment of the surveillance device 210 includes an encryption module 218. The encryption module 218 can include any combination of software agents and/or hardware modules able to encrypt the recorded information for storage and/or transmission purposes to prevent unauthorized use or reproduction.

Any or a portion of the recorded images, video data, and/or audio data may be encrypted by the encryption module 218. In addition, any location data determined by the location sensor 208 or supplemental information generated by the surveillance device 210 may also be encrypted. Note that the encryption may occur after recording and before storage in local memory 212 and/or local storage 214 such that the recordings and any additional information are stored in encrypted form.

Thus, any unauthorized access to the surveillance device 210 would not cause the integrity of data stored therein to be compromised. For example, even if the local storage unit 214 or surveillance device 210 were physically accessed by an unauthorized party, they would not be able to access, review, and/or reproduce the recoded information that is locally stored. Note that in the local storage unit 214, recorded data may be stored in encrypted form or in un-encrypted form.

In addition, the recording may be transmitted/uploaded to the remote server in encrypted form. If the encryption was not performed after the recording, the encryption can be performed before transmission over the network. This prevents the transmitted data from being intercepted, modified, and/or reproduced by any unauthorized party. The remote server (host server) receives the encrypted data and can also receive the encryption key for decrypting the data for further review and analysis. The encryption module 218 can encrypt the recorded data and any additional surveillance data/supplemental information using any known and/or convenient algorithm including but not limited to, 3DES, Blowfish, CAST-128, CAST-256, XTEA, TEA, Xenon, Zodiac, NewDES, SEED, RC2, RC5, DES-X, G-DES, and/or AES, etc.

In one embodiment, the surveillance device 210 encrypts and encodes the recording and uploads the recording in the encrypted and encoded form to the remote server (e.g., host server 124 of FIGS. 1A-1B).

The memory unit 212 and/or the storage unit 214 of the surveillance device 210 are, in some embodiments, coupled to the processing unit 226. The local storage unit 214 can include one or more disk drives (e.g., a hard disk drive, a floppy disk drive, and/or an optical disk drive). The memory unit 212 can include volatile (e.g., SRAM, DRAM, Z-RAM, TTRAM) and/or non-volatile memory (e.g., ROM, flash memory, NRAM, SONOS, FeRAM, etc.).

The recordings captured by the capturing unit 204 and location data detected or generated by the location sensor 208 can be stored in the memory unit 212 or location storage unit 214, before or after processing by the processing unit 226. The local storage unit 214 can retain days, weeks, or months of recordings and surveillance data provided by the capturing unit 204 and the location sensor 208. The data stored in local storage 214 may be purged automatically after a certain period of time or when storage capacity reaches a certain limit. The data stored in the local storage 214 may be encoded or un-encoded (e.g., compressed or non-compressed). In addition, the data stored in local storage 214 may be encrypted or un-encrypted.

The surveillance data stored in local storage 214 can be deleted through a backend server/processing center that communicates with the surveillance device 210 over a network (e.g., the host server 124 of FIGS. 1A-1B). In addition, the surveillance data having the recordings may be previewed from the backend server/processing center and coupled with the option of selecting which set of recordings and data to download from the surveillance device 210 to the backend server/processing center. After the upload, the option to delete the data from the local storage 214 of the surveillance device 210 also exists.

When storage capacity is approaching a limit, the surveillance data stored in local storage 214 can be automatically deleted in chronological order beginning from the oldest data. The stored surveillance data can be deleted until a certain amount of storage space (e.g., at least 20%, at least 30%, at least 40%, etc.) becomes available. In one embodiment, the surveillance data stored in the local storage unit 214 is encoded or compressed to conserver storage space. When the storage capacity is approaching a limit, the compression ratio may automatically or manually increase such that more recordings can be stored on the storage unit 214.

One embodiment of the surveillance device 210 further includes a controller 220 coupled to the memory unit 212 and local storage unit 214. The controller 220 can manage data flow between the memory unit 212, the storage unit 214, and the processing unit 226. For example, the controller 220 manages and controls the upload of recorded data and surveillance data stored in the memory 212 or storage unit 214 to a backend server/processing center through the network interface 202.

The controller 220 can control the upload the recorded data and surveillance data from the storage unit 214 to a remote server/processing center at predetermined intervals or predetermined times. In addition, the controller 220 can automatically upload the data from the storage unit 214 upon detection of a triggering event. In one embodiment, upon detection of a triggering event, the surveillance device 210 uploads, in real time or near real time, the recordings and any associated location data stored in memory 212 or local storage 214 to a remote server via the network interface 202.

In one embodiment, the controller 220 is operable to control the image capture settings of the image/camera sensors in the capturing unit 204. For example, the controller 220 enables video capture that occurs subsequent to the detection of the triggering event to be recorded at a higher resolution than before the detection of the triggering event or without having detected the triggering event. The high resolution video can be stored in the storage unit 214. In addition, in one embodiment, another copy of the higher resolution recording is created and stored in memory 212 or the storage unit 214 in compressed form.

In one embodiment, the controller 220 can be operable to control the encoding module 216 to compress the high resolution video recorded by the image sensors in the capturing unit 204. The compressed version can be used for live streaming to other devices such as a host server or a user device (e.g., computer, cell phone, etc.)

One embodiment of the surveillance device 210 includes a motion sensor/event detector 222. The motion sensor/event detector 222 can include any combination of software agents and/or hardware modules able to detect, identify, quantify motion via a sensor.

The motion sensor 222 can operate via detecting optical, acoustic, electrical, magnetic, and/or mechanical changes in the device in response to a motion, change in speed/velocity, temperature, and/or shock, for example. In addition, the motion sensor 222 can further include heat (e.g. infrared (IR)), ultrasonic, and/or microwave sensing mechanisms for motion sensing.

The controller 220 may be coupled to the motion sensor 222. When motion is detected by the motion sensor 222 in the vicinity or nearby areas of the surveillance device 210, the controller 220 then can begin to upload recorded data and any supplemental surveillance data from the memory 212 and/or storage units 214 to the remote server/processing center. In one embodiment, the detection of the triggering event by the motion sensor 222 includes detection of human activity or human presence. In one embodiment, human presence and/or human activity are detected by sensing temperature (e.g., via a infrared sensor or other types of temperature sensors) In addition to sensing motion, the motion sensor 222 includes a G-force sensor that is able to sensor a g-force (e.g., gravity), free-fall, and/or a turn.

One embodiment of the surveillance device 210 includes an accelerometer 224. The accelerometer (e.g., a three-axis accelerometer) can be coupled to the motion sensor 222. In some embodiments, the accelerometer is used in lieu of the motion sensor 222. The accelerometer 224 can be used to detect movement, speed, velocity, and/or acceleration of the surveillance device 210. Upon detection of movement or speed/acceleration that exceeds a threshold or falls within a set range, the controller 220 can be triggered to begin the upload of data from the memory 212 and/or storage unit 214 to the remote server/processing center.

The threshold of speed or acceleration typically depends on the environment in which the surveillance device 210 is deployed and the intended application. For example, the surveillance device 210 may be installed in/on a mobile unit and is thus constantly in motion during operation thus a triggering event would likely be detection of acceleration or speed that exceeds a certain threshold. If the surveillance device 210 is installed in a moving vehicle, for example, the threshold speed may be set to be 85 mph, above which, the recorded data begins to be uploaded to the remote server.

One embodiment of the surveillance device 210 further includes one or more temperature sensors 228. The one or more temperature sensors 228 can include sensors to measure the ambient temperature. In addition, a sensor can be used to measure and track the temperature of processing elements (e.g., the processing unit 226) in the surveillance device 210. The temperature of the wireless transmitter/receiver can be monitored and tracked by a temperature sensor as well.

In one embodiment, the temperature sensor 228 includes one or more infrared sensors. The infrared sensors or other types of temperature sensors can be used to detect human presence or human activity, for example.

In some embodiments, any portion of or all of the functions described herein of the surveillance and monitoring functionality of the processing unit 226 can be performed in one or more of, or a combination of software and/or hardware modules external or internal to the processing unit, in any known or convenient manner

The surveillance device 210 represents any one or a portion of the functions described for the modules. More or less functions can be included, in whole or in part, without deviating from the novel art of the disclosure.

FIG. 2B depicts diagrammatic representations of examples of the image capture unit in the surveillance device.

FIG. 2C depicts a diagrammatic representation of images captured with the image capture unit and the combination of which to generate a panoramic view 270.

In the example configuration 230, a camera/image sensor 233 is used with mirror 231 and mirror 235 to capture regions not able to be captured by sensor 233. In configuration 230, if an image of resolution 480×640 is captured, the mirror 231 captures the top ⅓ of the image (e.g., 180×640 portion 252 in FIG. 2C), the sensor 233 captures the center ⅓ of the image (e.g., the center 180×640 portion 254 in FIG. 2C), and the mirror 235 captures the bottom ⅓ of the image (e.g., the lower 180×640 portion 256 in FIG. 2C). Each of the three portions can be combined to generate an image of 480×640 pixels. The combination of images captured by the sensor/mirror configuration 230 is illustrated in FIG. 2C in the set of images 250.

In the example configuration 240 of FIG. 2B, the image capture unit includes three camera sensors (e.g., sensor 232, 234, and 236). In general, each camera sensor can have a different field of view. When each camera sensor has non-overlapping field of views with adjacent sensors, the cumulative field of view is generally the addition of the field of view provided by each sensor. For example, if each sensor is able to capture 60-80 degrees, then the capturing unit in configuration 240 generally has a field of view of ˜180-240 degrees.

The combination of images captured by configuration 246 is illustrated in FIG. 2C in the set of images 260. Image 242 can be captured by sensor 232, image 244 can be captured by sensor 234, and image 246 can be captured by sensor 236. The series of images 242, 244, and 246 can be concatenated and combined serially to generate the panoramic view 270 of FIG. 2C. In some instances, when a particular sensor is positioned to capture specific event of interest, the images captured with the particular sensor having the relevant point of view can be stored and uploaded to the remote server without the other images, for example, to conserve resources and optimize uploading time.

Note that at the user end when the panoramic view 270 is being observed, for example, at the host server or remote processing center, the region of interest 275 can be selected for viewing. In addition, once the region/object of interest 275 has been selected, the surveillance device may upload to the host server, just images of the region/object of interest.

FIG. 3A depicts the top side view 301 and the rear view 321 of an example of a surveillance device 310

In one embodiment, the surveillance device 310 includes menu/select buttons (e.g., left and/or right buttons 303 and 305). The menu/select button(s) can be used by a user for navigating through functions displayed on the display 309, for example. The surveillance device 310 can also include, for example, a flash reader 311, a USB port 313, and/or a RJ11 port 317.

In one embodiment, the surveillance device 310 includes an extension port 315 (e.g., a 25×2 pin extension port). The LED(s) 307 can be used as status indicators to indicate the operation status of the surveillance device 310, for example. In one embodiment, the surveillance device 310 can include a panic button 303. The panic button 303 can be activated by a user, for example, to indicate that an event is occurring or to request attention of authorities or service agents.

Upon activation, a set of events can be triggered. For example, the surveillance device 310 can begin uploading or streaming recordings to remote processing centers, hosts, and/or devices. Upon activation, the recording captured by the surveillance device 310 may be performed in a higher resolution than prior to the activation of the panic button 303.

In one embodiment, the surveillance device 310 includes a mounting slot 323. The mounting slot 323 can be seen in the rear view 321 of the device 310.

FIG. 3B depicts the front view 231, bottom view 241, and side view 251 of an example of a surveillance device 310.

The enclosure of the surveillance device 310 includes a camera lens 333 on the side where the camera/image sensors internal to the device 310 face outwards. The lens 333 can be seen in the front view 331 of the device 310. One embodiment of the surveillance device 310 includes a reset button 343. In addition the surveillance device 310 can include a speaker 353 for playback of audio.

FIG. 4 depicts a series of screenshots 400, 410, 420, 430, 440 of example user interfaces and icons 440 and 450 shown on the display of a surveillance device.

Screenshot 400 illustrates an example of the welcome screen. Screenshot 410 illustrates an example of the default display. One embodiment of the default display shows an SMS/voicemail icon 402 indicating the presence of an SMS or voicemail message. A signal strength indicator 405, GPS reception indicator 401, a battery level indicator can also be shown in the default screen. One embodiment further includes a compass indicator 404 and/or an event indicator 406. Other indicators (e.g., “EV:2”) can show the number of events (e.g., G-force, acceleration, human activity, heat, etc.) that have been detected.

Screenshot 420 illustrates an example of a menu page. In one embodiment, the menu page includes menu access to the event history 421, SMS/voicemails 422, configuration device settings 423, g-force graph 424, GPS location 425, volume settings/tone 426, etc.

Screenshot 430 illustrates an example of another menu page. In one embodiment, the menu page includes menu access to the calibration 431, Internet 432, the camera menu 433 where pictures can be accessed, history 434, tools 435, and/or firmware version information 436. The calibration 431 button can be used by the user to see the field of view being imaged by the surveillance device. When calibration 431 is selected, the field of view of the camera in the surveillance device is shown on the display. Based on the display, the user can adjust the positioning of the surveillance device until desired field of view is shown on the display. The history 434 button can be selected to view a history of commands and/or events.

FIG. 5 depicts another example of an asset monitoring unit 500 including a surveillance device 510.

In one embodiment, the surveillance device 510 can be secured in an enclosure 512 having a battery compartment 524. The enclosure 512 can be formed from steel. The enclosure 512 includes a door 526 that can be opened to access the surveillance device 512 within and closed to secure the device 512 within using a lock, for example. The enclosure can be coupled to a GPS antenna 520 and a COM antenna 522.

Further, the enclosure 512 includes an opening 514 for the motion sensor in the surveillance device 510 to project into space external to the enclosure 512. The enclosure 512 may further include an opening 516 for the image capture unit in the surveillance module 510 to capture images of space external to the enclosure 512 and another opening 518 for projecting infrared or near infrared light into external space. In general, the sensor detection range of the surveillance device 510 in the enclosure 512 is approximately 50-150 feet and the night vision range is approximately 100-300 feet.

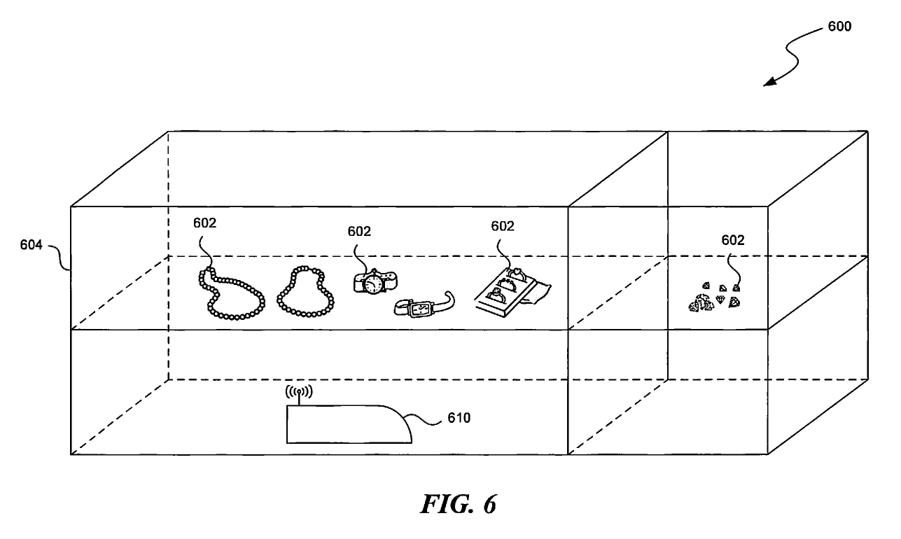

FIG. 6 depicts a diagram 600 of an example of a surveillance device 610 used in a surveillance system for theft-prevention of theft-prone goods 602, according to one embodiment.

In an example application, the surveillance device 610 can be placed to monitor theft-prone goods 602 such that they are within the field of view of the cameras/sensors in the surveillance device 610. In the illustrated example, the theft prone goods 602 include necklaces, watches, rings, and diamonds displayed in a secured display shelf 604 with glass panels in a store. Other types of theft-prone good are also contemplated and the surveillance device 610 can be used for theft prevention of these goods, without deviating from the spirit of the novel art.

The surveillance device 610 can include a capturing unit, a local storage unit, and/or a motion sensor. The surveillance device 610 can be placed and oriented such that the theft-prone goods 602 are within vicinity and within the viewing angle of the surveillance device 610 such that the capturing unit can capture a recording of the surrounding environment and the events occurring therein. The recordings can be stored in the local storage of the surveillance device 610.

Upon detection of motion (e.g., motion that is indicative of human activity and/or human presence), the surveillance device 610 can automatically begin to upload the recording to a remote server/processing center coupled to the surveillance device 610 in real time or in near real time. In addition, the type of motion that triggers upload can include shock detection or sound detection indicative of a break-in or commotion in the near-by areas. The surveillance device 610 and the host server may be coupled over the Internet or the cellular network, for example.

The recording can include a video recording of the human activity and in some instances, the associated locations of the human in the video recording. Therefore, if the surveillance device 610 detects a break-in of the display shelf 604, live recordings occurring after the break-in are now transmitted and previewed by a remote entity monitoring the remote server at the processing center.

Since in some embodiments, the surveillance device 610 includes a location sensor, the location data of the human captured in the recording can be determined and transmitted to the remote server as well. The remote server can receive the recording (e.g., including the video recording of the human activity) and the additional location data and can further notify an assistance center (e.g., security services or a law enforcement agency).

The surveillance device 610 can be configured to be active during certain times of a day, days of week, months of the year, etc., depending on the application. The surveillance device 610 can automatically switch on when it is time for the surveillance device to be activated. Alternatively, the surveillance device 610 can always be on but automatically switches between active and inactive modes depending on default settings or configured settings. In one embodiment, the motion sensor in the surveillance device 610 may be de-activated or switched off when surveillance is not desired or when the surveillance device is programmed to be “off” or “inactive”.

In one embodiment, the surveillance device 610 includes or is coupled to a night vision device to assist in capture of the recording of the surrounding environment and events in low lighting situations such as a night time. Although only one surveillance device 610 is illustrated, any number of surveillance devices can be deployed.

In the surveillance system, a user device may also be coupled to the remote server that receives surveillance data from the surveillance device 610. The user device can be coupled to the remote server via a wireless network such as a cellular network or the Internet. The user device may be a device (e.g., a computer, a server, a cell phone, a laptop, etc.) operated by assistive services. Assistive services may be notified by the remote server communicating with the associated user devices. For example, the remote server can provide the recording captured by the surveillance device 610 or a portion thereof to the user device in a web interface or email message. In addition, the recording or a notification can be provided by the remote server to the user device via a phone call or a text message via a telephone network (e.g., ISDN, VoIP, POTS, and/or cellular/mobile phone network).

In one embodiment the user device is also used to remotely control the operations of the surveillance device 610. For example, the user device can be used by assistive services to request recorded data from a period of time when the recording was not uploaded to the remote server, for instance, before the detection of a triggering event. In addition, the user device can be used by assistive services to manually request or cease broadcast of recorded data to the user devices.

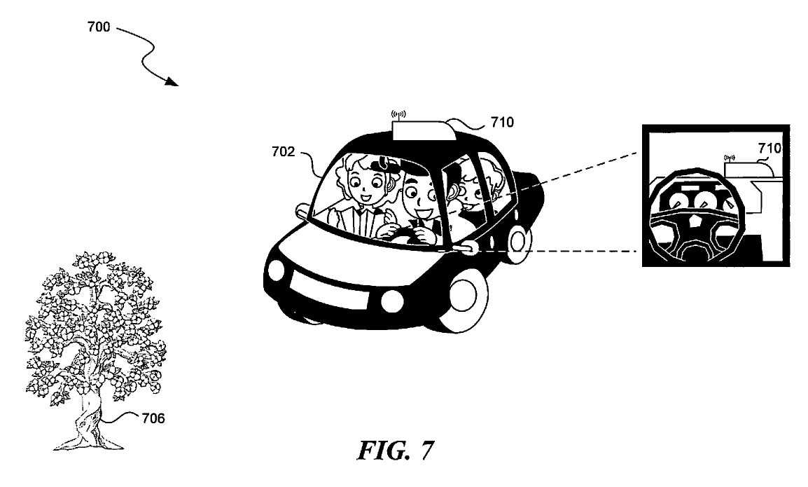

FIG. 7 depicts a diagram 700 of an example of a surveillance device 710 used in a surveillance system for surveillance and recordation of events inside and outside of a vehicle 702, according to one embodiment.

The surveillance device 710 can be installed with the vehicle 702. For example, the surveillance device 710 may be placed or installed on top of the vehicle, inside the vehicle (e.g., on the dashboard), or one in each location. In one embodiment, the surveillance device 710 includes a mounting slot (e.g., the mounting slot 323 in the example of FIG. 3A) for mounting in or on a mobile unit (e.g. vehicle 702). The surveillance device 710 generally includes a capturing unit and local storage.

When the surveillance device is in operation, the capturing unit captures a recording of the surrounding environment and events that are occurring near the vehicle 702 when in motion or sitting still. The recording can be stored in local storage unit in the surveillance device 710. In general, the recording includes live video data and/or live audio data of the environment and events occurring both inside and outside of the vehicle 702 synchronized to the live video data. However, depending on the placement of the surveillance unit 710, the recording may include only video and/or audio from inside or outside of the vehicle 702.

The surveillance device 710 may also include a location sensor (e.g., a GPS receiver) that can determine the location data of the surveillance device 710 and the vehicle 702 it is installed on/with. From determining the location data of the surveillance device 710 and the vehicle 702, a location map (e.g., GPS map) of the surrounding environment/events captured in the recordings can be generated by the surveillance device and stored in local storage. The location map can include locations (e.g., graphical or textual depictions) of the places captured in the recordings (e.g., locations where the vehicle 702 has traveled).

Thus, when the recorded data and location data (or location map) is uploaded to a remote server that is coupled to the surveillance unit 710, a reviewer at the remote server can determine where the vehicle 702 is or has been. In one embodiment, when the surveillance device 710 detects a triggering event (e.g., by way of a motion detector or accelerometer), the surveillance device can begin to upload the recording to the remote server.

The triggering event may be manual activation of a panic button on the surveillance device 710. The triggering event may also be the occurrence of the crash of the vehicle 702 or detection of an event/situation that is indicative of a vehicle crash (e.g., sudden stop, dramatic decrease in speed, heat, change in temperature, etc.). The detection of the triggering event may be by a component (e.g., motion sensor, heat sensor, accelerometer etc.) internal to the surveillance device 710 or a device (e.g., motion sensor, heat sensor, accelerometer etc.) externally coupled to the surveillance device 710.

The recording that is uploaded generally includes the live recording of the surrounding environment and events that occurred subsequent to the detection of the triggering event. In some embodiments, the uploaded recording can include previously occurred recordings (recording that occurred before the triggering event) over a certain amount of time (e.g., 1, 2, 5 minutes before the triggering event). This amount of time can be preset and/or can be (re)configured.

In addition, the location map associated with the recording is also uploaded to the remote server such that real time or near real time location of the vehicle 702 is transmitted to the remote server/processing center. When the remote server receives the recording, at least a portion of the recording can be broadcast to a device coupled to the remote server. The device may be operated by a law enforcement officer, for example, and can thus preview the recording using the device. The location data of the vehicle 702 may also be broadcast to the device or multiple devices for use by various law enforcement officers.

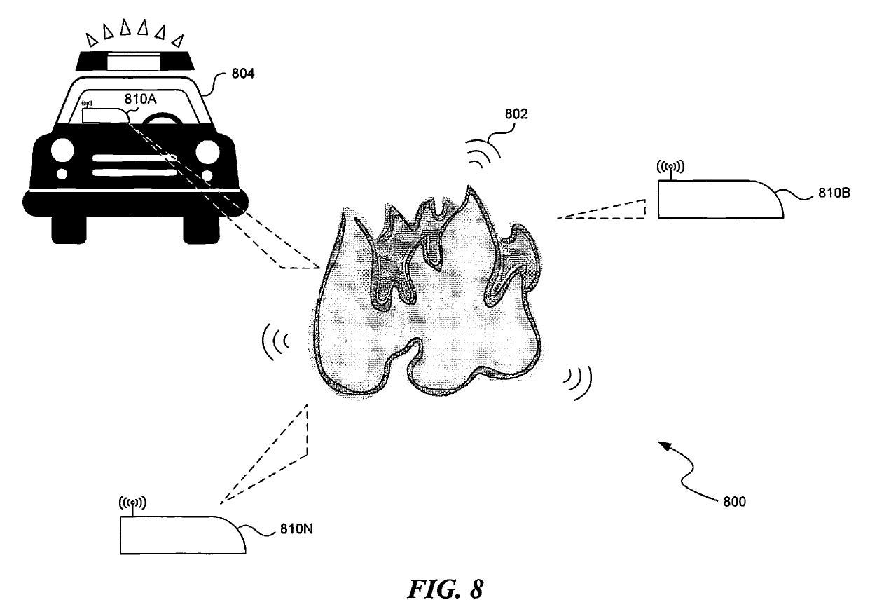

FIG. 8 depicts a diagram of an example of using multiple surveillance devices 810A-N that triangulate the location of a hazardous event 800 by analyzing the sound 802 generated from the hazardous event 800, according to one embodiment.

The multiple surveillance devices 810A-N may be installed on a mobile or fixed unit that is indoors or outdoors. For example, surveillance device 810A is installed in or with a police car 804. The other surveillance devices 810B and 810N may be installed in other mobile units (e.g., cars, motorcycles, bicycles, helicopters, etc.) or in/on nearby infrastructures (e.g., in a building, underground, on a bridge, etc.).

When a hazardous event 800 occurs and a sound 802 is generated, the surveillance devices 810A-N detect the sound and can triangulate the location of the source of the sound and thus the location of the hazardous event 800. The triangulation of location can be performed automatically on-the-spot in real time. The real time determination of the location of the hazardous event/situation can assist emergency services or authorities in resolving the situation and identifying a pathway that does not pose significant danger to the authorities deployed resolve the situation.

The triangulation can also be a post analysis requested after the occurrence of the event 800. The post analysis can assist authorities in obtaining information about the event and identifying the cause or source, for example. The hazardous event 800 may be an explosion, a gun shot, multiple shootings, a scream, a fight, a fire, etc.

Note that any number of surveillance devices 810 can be used for triangulation of sound location at some degree although the precise location can be determined with increased precision with more surveillance devices.

For example, with one surveillance device 810, the direction of the sound can be determined. With two surveillance devices 810, the position of the sound source can be determined to two coordinates (e.g., distance and height; or x and y) and with three surveillance devices, the position can be determined to three coordinates (e.g., distance, height, and azimuth angle; or x, y, and z).

Note that the surveillance device 810 can include pattern recognition capabilities implemented using microphones and software agents to learn the type of sound for which the source location is to be triangulated.

Although specific examples of applications where surveillance devices and surveillance systems can be deployed are illustrated, it is appreciated that other types of applications and environments where the described surveillance devices and systems can be deployed are contemplated and are considered to be within the novel art of this disclosure. By way of example but not limitation, the described surveillance device and system can be used for remote surveillance in employee monitoring, airport security monitoring, infrastructure protection, and/or deployment of emergency responses.

FIG. 9 depicts a block diagram illustrating the components of the host server 924 that generates surveillance data and tactical response strategies from surveillance recordings, according to one embodiment.

The host server 924 includes a network interface 902, a billing module 904, a tactical response generator 906, a location finder 908, a memory unit 912, a storage unit 914, an encoder/decoder 916, an encryption/decryption module 918, a broadcasting module 920, an event monitor/alert module 922, a web application server 932, a processing unit 926, and/or a surveillance device manager 934. The host server 924 may be further coupled to a repository 928 and/or an off-site storage center 930.

Additional or less modules can be included without deviating from the novel art of this disclosure. In addition, each module in the example of FIG. 9 can include any number and combination of sub-modules, and systems, implemented with any combination of hardware and/or software modules.

The host server 924, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 9, the network interface 902 can be a networking device that enables the host server 924 to mediate data in a network with an entity that is external to the host server, through any known and/or convenient communications protocol supported by the host and the external entity. The network interface 902 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

One embodiment of the host server 924 includes a billing module 904. The billing module 904 can be any combination of software agents and/or hardware modules able to manage tactical response deployment services, subscription-based surveillance services, and/or crisis analysis services.

The surveillance services provided to customers can include centralized monitoring of recordings captured by deployed surveillance devices and/or notification of authorities upon detection or observation of an event that requires attention of authorities or a service center. The customer can specify the types of event that when occurred, require notification.

The services can also be provided to customers by deploying a web interface through which customers can remotely monitor the recordings captured by surveillance devices or other imagers. The web interface provided can allow the end user/customer to select the recordings to view and/or to perform various analyses of the recordings through the web interface. Customers can subscribe to such services on a month-to-month or year-to-year basis.

In one embodiment, the billing module 904 bills service subscribers for subscription of remote monitoring of the mobile vehicle. For example, a networked surveillance device (e.g., the surveillance device 210 of FIG. 2A) can detect an occurrence of a triggering event in or near the mobile vehicle. The triggering event can include a crash or a shock or other types of events. The host server 924, upon the occurrence of the triggering event, receives, in real time or near real time, data including a live recording of an environment surrounding the mobile vehicle and events occurring therein. The host server 924 can notify the service subscriber of the occurrence of the triggering event.

In one embodiment, the billing module 904 bills service subscribers for subscription for remotely monitoring the stationary asset. The surveillance device can detect, for example, an occurrence of human activity via a surveillance device disposed near the stationary asset and recording, in real time, a high resolution video of an environment surrounding the stationary asset and events occurring nearby, upon the occurrence of the human activity. The recording can be transmitted to and received by the host server 924, in real time or near real time. In one embodiment, the host server 924 also notifies the service subscriber of the occurrence of the human activity.

In one embodiment, the billing module 904 bills a user for subscribing to a remote travel guidance service. For example, the surveillance device can, track, in real time, locations of a mobile vehicle in which a user is navigating. Further, according to a guided tour plan, the user can be provided with driving directions based on the locations of the mobile vehicle in real time. The host server 924 can then audibly render travel information to the user according to scenes and sites proximal to the mobile vehicle.

The memory unit 912 and/or the storage unit 914 of the host server 924 are, in some embodiments, coupled to the processing unit 926. The storage unit 914 can include one or more disk drives (e.g., a hard disk drive, a floppy disk drive, and/or an optical disk drive). The memory unit 912 can include volatile (e.g., SRAM, DRAM, Z-RAM, TTRAM) and/or non-volatile memory (e.g., ROM, flash memory, NRAM, SONOS, FeRAM, etc.).

The recordings and any other additional information uploaded by the surveillance devices (e.g., surveillance device 210 of FIG. 2) can be stored in memory 912 or storage 914, before or after processing by the processing unit 926. The storage unit 914 can retain days, weeks, or months of recordings and data uploaded from the surveillance device or multiple surveillance devices. The surveillance data stored in storage 214 may be purged automatically after a certain period of time or when storage capacity is reaches a certain limit. The recorded data or surveillance data stored in the storage unit 914 may be encoded or un-encoded (e.g., compressed or non-compressed). In addition, the data stored in the storage unit 914 may be encrypted or un-encrypted.

The recorded data and surveillance uploaded from the surveillance devices can be input to the processing unit 926. The processing unit 926 can include one or more processors, CPUs, microcontrollers, FPGAs, ASICs, DSPs, or any combination of the above. Data that is transmitted from the surveillance devices processed by the processing unit 926 and broadcast via a wired or wireless connection to an external computer, such as a user device (e.g., a portable device) by way of the broadcasting module 920 using the network interface 902.

The processing unit 926 can also include an image processor and/or an audio processor. The processing unit 926 in the host server 924 can analyze a captured image/video to detect objects or faces for identifying objects and people of interest (e.g., via object recognition or feature detection), depending on the specific surveillance application and the environment in which the surveillance device is deployed. These objects may be highlighted in the video when reviewed on the host server 924 and/or when broadcast to user devices.

The processing unit 926 can also perform audio processing on captured audio of the surrounding environments and the nearby events of the surveillance devices uploaded to the host server 924. For example, frequency analysis can be performed on the recorded audio uploaded by the surveillance devices. In addition, the processing unit 926, using the location data associated with the places and objects in the captured images/audio uploaded from surveillance devices, can determine the location or approximate location of the source of the sound. In one embodiment, using the audio data captured using multiple surveillance devices uploaded to the host server 924, the location of the source of the sound can be determined via triangulation by the audio processor and processing unit 926. One embodiment of the host server 924 includes a location finder 908.

The location finder 908 communicates with the processing unit 926 and utilizes the uploaded video and/or audio data to determine the location of any given event captured by coupled surveillance devices. Furthermore, the location finder 908 can determine the location of any given object or person captured in the image/video and in different frames of a given video, for example, using location data provided by the surveillance devices. Since surveillance devices can be installed on moving units, location tracking and location finding abilities of the host server 924 may be particularly important when surveillance reveals events (e.g., emergency event) occurring that require immediate attention.

One embodiment of the host server 924 includes an encoder/decoder 919. The encoder/decoder 916 can include any combination of software agents and/or hardware modules able to convert the uploaded recording (which may be encoded or un-encoded) and any additional information from one format to another via decoding or encoding. The encoder/decoder 916 can include a circuit, a transducer, a computer program, and/or any combination of the above. Format conversion can be for purposes of speed of transmission and/or to optimize storage space by decreasing the demand on storage capacity of a given recording.

In one embodiment, the encoder/decoder 916 de-compresses data (e.g., images, video, audio, etc.) uploaded from surveillance devices or other devices. The data may have been encoded (compressed) by the surveillance devices that recorded/generated the data. The decompressed data can then be stored in memory 912 or local storage 914 for reviewing, playback, monitoring, and/or further processing, for example, by the processing unit 926. In addition, the de-compressed data may be broadcast to one or more user devices from the remote server 924 in uncompressed form.

In one embodiment, the encoder/decoder module 916 reconstitutes data files using data blocks received over the network (e.g., streamed from surveillance devices or other devices). The encoder/decoder module 916 of the host server 924 can also compute the checksums of the data blocks received over the network. The checksums can be stored on the host server 924 (remote server) and used for reconstituting the data file. The reconstituted data file (which may be encrypted or un-encrypted) can then be stored locally on the server 924 in memory or storage and provided for access (e.g. editing, viewing, listening, etc.)

Note that the checksum is computed by the host server 924 using the same algorithm as the device (e.g., the surveillance device 210 of FIG. 2A) that sent the data blocks. The checksum can be computed by the encoder/decoder module 916 on encrypted or un-encrypted data blocks received from the networked device (e.g., surveillance device).

Although, in general, the checksum values computed by the host server 924 is computed from the encrypted data if the checksum computed by the device is also from the encrypted data. Similarly, if the checksum is computed on unencrypted data by the surveillance device, then the host server 924 also computes the checksum on unencrypted data. In this manner, the checksum values can be used to determine whether data blocks contain the same content.

Further the host server 924 or the encoder/decoder 916 also receives the short message generated from the networked device identifying the locations in a data file where a data block is to be re-used/duplicated. The server stores the data blocks and/or the corresponding messages (e.g., short messages) in a database in local storage and retrieves the blocks to re-generate the full data file using the short message. If the data received from the networked device is encrypted, the host server 924 can decrypt (e.g., via the encryption/decryption module) the data and store the decrypted version of the data on the server 924. Alternatively, the host server 924 can store the encrypted version of the data blocks.

In one embodiment, the encoder/decoder 916 compresses data (e.g., images, video, audio, etc.) uploaded from surveillance devices. The data captured or generated by the surveillance devices may not have been encoded or otherwise compressed. The recorded and surveillance data can then be stored in memory 912 or local storage 914 in compressed form to conserve storage capacity. In addition, the compressed data can be broadcast to one or more user devices from the remote server 924 to conserve transmission bandwidth thus optimizing broadcast speed to user devices. The user devices can include the software to decompress the data for review and playback. In some instances where bandwidth is of lesser concern, data may be broadcast from the remote server 924 to user devices in uncompressed form.

In one embodiment, the recorded video is encoded by the encoder/decoder 919 using Motion JPEG (M-JPEG). The compression ratio for Motion JPEG recording can be automatically adjusted, for example, based on original file size and target file size. The target file size may depend on available storage space in the storage unit 914 of the host server 924. The compression ratio can also be determined in part by network capacity.

In one embodiment, the encoding module 916 is coupled to the processing unit 229 such that images, videos, and/or audio uploaded from surveillance devices can be compressed or decompressed. The compression and decompression can occur prior to storage and/or being broadcasted to user devices. Note that in the storage unit 914, recorded and/or surveillance data may be stored in encoded form or un-encoded form.

One embodiment of the host server 924 includes an encryption/decryption module 918. The encryption/decryption module 918 can include any combination of software agents and/or hardware modules able to encrypt and/or decrypt the recorded data and/or surveillance data on the host server 924 to prevent unauthorized use or reproduction.

Any or a portion of the recorded images, video data, textual data, audio data, and/or additional surveillance data may be encrypted/decrypted by the encryption/decryption module 918. In addition, any location data determined by the surveillance devices or supplemental information generated by the surveillance devices may also be encrypted/decrypted. Note that the encryption may occur after upload of the recorded and/or surveillance data by the surveillance devices and before storage in the storage unit 914 such that the recordings and any additional information are stored on the host server 924 in encrypted form.

As a result of storing data in the storage unit 914 in encrypted form, any unauthorized access to the host server 924 would not cause the integrity of recorded data and/or surveillance data stored therein to be compromised. For example, even if the storage unit 914 or host server 924 were physically accessed by an unauthorized party, they would not be able to access, review, and/or reproduce the recoded information that is locally stored, without access to the encryption key. Note that in the storage unit 914, recorded data may be stored in encrypted form or in un-encrypted form.

Alternatively, the recording may be transmitted/uploaded to the remote server 924 from the surveillance devices in encrypted form. The encryption can be performed by the surveillance device before transmission over the network to the host server 924. This prevents the transmitted data from being intercepted, modified, and/or reproduced by any unauthorized party. In one instance, the surveillance devices can transmit the encryption keys used for data encryption to the remote server/processing center (host server 924) for decrypting the data for further review and analysis. Different surveillance devices typically use different encryption keys which may be generated by the individual surveillance devices.

In another instance, the host server 924 maintains a database of the encryption keys used by each surveillance device and updates the database when changes occur. The encryption keys used by surveillance devices may be assigned by the host server 924. The same encryption key may be used by a particular surveillance device for a predetermined amount of time. In one embodiment, the host server 924 re-assigns an encryption key to a surveillance device for use after a certain amount of time.

The encryption/decryption module 918 can encrypt/decrypt the recorded data and any additional data using any known and/or convenient algorithm including but not limited to, 3DES, Blowfish, CAST-128, CAST-259, XTEA, TEA, Xenon, Zodiac, NewDES, SEED, RC2, RC5, DES-X, G-DES, and/or AES, etc.

In one embodiment, the host server 924 encrypts and/or encodes the recording and broadcasts the recording in the encrypted and encoded form to one or more user devices (e.g., user device 102 of FIGS. 1A-1B). For example, the host server 924 encrypts data using a government-approved (e.g., NSA approved) encryption algorithm and transmits the encrypted data to a device operated by government authority. In general, the government official or law enforcement agency has access to the encryption keys to access the data encrypted using the government approved encryption algorithm.

One embodiment of the host server 924 includes a tactical response generator 909. The tactical response generator 906 can include any combination of software agents and/or hardware modules able to generate a tactical response given an emergency or hazardous situation.

The emergency or hazardous situation can be determined from surveillance data and recordings uploaded from various surveillance devices. In some instances, the remote server 924 may receive uploads of recordings from multiple surveillance devices deployed in the vicinity of one area having a situation or event that requires attention. The recordings and additional information gathered by the tactical response generator 906 from multiple surveillance devices can be used to obtain information about the emergency or hazardous event.

For example, by analyzing images/video captured by surveillance devices, the people involved in the incident can be detected an in some instances identified, for example, through facial or feature recognition techniques. The number of people involved and/or the number of people endangered may be determined. In addition, the infrastructure surrounding the incident and their associated locations can be determined. In addition, by analyzing audio captured by the surveillance devices, locations of the sources of sound, the source of the sound, can be determined.

Note that the surveillance devices, either in motion or still, can provide location data associated with the situation/event. For example, the location data can include the location of the surveillance device, location of moving objects in captured images/videos,

This information, alone or in conjunction, whether generated by the response generated 909 or retrieved from another module (e.g., the processing unit 926) can be used to generate strategies for tackling the incident or situation. For example, the strategy can include identification of points of entry to the situation that are unobstructed or otherwise safe from hazards and perpetrators. The strategy may further include an identification of one or more pathways to navigate about the incident to rescue individuals at risk.

The tactical response strategy may be broadcasted by the broadcasting module 920 to multiple user devices. These user devices can be operated by assistive services individuals including emergency services, fire fighters, emergency medical services individuals, an ambulance driver, 911 agents, police officers, FBI agents, SWAT team, etc. The devices that the tactical response strategies are broadcast to depend on the strategy and the needs of the situation and can be determined by the tactical response generator 906.

In one embodiment, the event monitor/alert module 922 detects events and situations from the uploaded recordings and alerts various assistive services such as law enforcement authority, emergency services, and/or roadside assistance. The event monitor/alert module 922 can utilize the broadcasting module 920 to transmit the relevant recordings and data to user devices monitored by the various assistive services.

The recordings may be presented on user devices through a web interface which may be interactive. The web application server 932 can be any combination of software agents and/or hardware modules for providing software applications to end users, external systems and/or devices. The web application server 932 can accept Hypertext Transfer Protocol (HTTP) requests from end users, external systems, and/or external client devices and responding to the request by providing the requesters with web pages, such as HTML documents and objects that can include static and/or dynamic content (e.g., via one or more supported interfaces, such as the Common Gateway Interface (CGI), Simple CGI (SCGI), PHP, JavaServer Pages (JSP), Active Server Pages (ASP), ASP.NET, etc.).

In addition, a secure connection, SSL and/or TLS can be established by the web application server 932. In some embodiments, the web application server 212 renders the web pages having graphic user interfaces including recordings uploaded from various surveillance devices. The user interfaces may include the recordings (e.g., video, image, textual, and/or audio) superimposed with supplemental surveillance data generated by the host server 924 from analyzing the recordings. In addition, the user interfaces can allow end users to interact with the presented recordings.

For example, the user interface may allow the user to pause playback, rewind, slow down or speed up playback, zoom in/out, request certain types of audio/image analysis, request a view from another surveillance device, etc. In addition, the user interface may allow the user to access or request the location or sets of locations of various objects/people in the recordings captured by surveillance device.

One embodiment of the host server 924 further includes a surveillance device manager 934. The surveillance device manager 934 can include any combination of software agents and/or hardware modules able to track, monitor, upgrade, surveillance devices that have been deployed.

Surveillance devices can be deployed in different areas for different types of surveillance purposes. The surveillance device manager 934 can track and maintain a database of where surveillance devices are deployed and how many are deployed in a given location, for example. In addition, the surveillance device manager 934 may be able to track the surveillance devices using their hardware IDs to maintain a database of manufacturing information, hardware information, software version, firmware version, etc. The surveillance device manager 934 can manage software/firmware upgrades of surveillance devices which may be performed remotely over a cellular network or the Internet.

One embodiment of the host server 924 is coupled to a repository 928 and/or an off-site storage center. The repository 928 can store software, descriptive data, images, system information, drivers, and/or any other data item utilized by other components of the host server 924, the surveillance devices and/or any other servers for operation. The off-site storage center may be used by the host server 924 to remotely transfer files, data, and/or recordings for archival purposes. Older recordings that have no immediate use maybe transferred to the off-site storage center for long-term storage and locally discarded on the host server 924.

The host server 924 represents any one or a portion of the functions described for the modules. More or less functions can be included, in whole or in part, without deviating from the novel art of the disclosure.

FIGS. 10A-B illustrate diagrams depicting multiple image frames and how data blocks in the image frames are encoded and transmitted for bandwidth optimization.

In the example of FIG. 10A, the master video frame 1002 and its subsequent version 1004 are illustrated. Assuming that these video frames are to be transmitted or uploaded to a networked device (e.g., a remote processing center or host server), either in real time or in delayed time, bandwidth usage can be conserved by noting that in this example, the subsequent frame 1004 only differs from the master frame 1002 by the addition of a bird 1005 in the image.

Thus, in some embodiments, rather than transmitting the subsequent frame 1004 in its entirety to the networked device, the portions of the subsequent frame 1004 that are different from the master frame 1002 can be transmitted to the networked device. Assuming that the networked device has the master frame 1002 in its entirety, the subsequent frame 1004 can be reconstituted by the host server using the portion 1005 that is different from the master frame 1002 and the master frame 1002 itself.

Changes in a video frame from the previous video frame can be identified by computing checksums (e.g., a signature) of the data blocks in the frame. The data blocks 1013, 1017 in the master frame 1002 and the data blocks 1015 and 1019 in the subsequent frame 1004 are illustrated in the example of FIG. 10B. The data blocks illustrated in the example are of 256 Byte-sized blocks. Each data block generally include non-overlapping data sets or non-overlapping pixels with the adjacent data blocks.

The checksum of each data block 1013, 1017 . . . of the master frame 1002 can be computed. Similarly, the checksum of each data block 1015, 1019 . . . of the subsequent frame 1004 can be computed. In one embodiment, the checksum values of the data blocks in the same file location (e.g., pixel location for video/image files) are compared (e.g., checksum 1016 of data block 1013 is compared with checksum 1018 of data block 1015 and checksum 1020 of data block 1017 is compared with checksum 1022 of data block 1019, etc.).

The comparison of each data block yields blocks with same or different checksum values. The data blocks in the subsequent frame 1004 whose checksum values are not equal to the checksum values of the corresponding data blocks in master frame 1002 can be transmitted to the networked device.

In one embodiment, not all of the data blocks of the master frame 1002 are transmitted to the networked device. For example, if checksum 1016 of data block 1013 equals checksum 1020 of data block 1017, then the contents of data blocks 1013 and 1017 are the same. Therefore, the content of data block 1013 may only need to be transmitted once to a networked device and used by the networked device at both block locations 013 and 1017.

In general, the checksum values of each data block in a particular frame can also be compared with the checksum values of other data blocks in the same frame to identify data blocks with the same content. If multiple data blocks have the same content, the content only needs to be transmitted once to the networked device and used at multiple data block locations when reconstituting the original data file.

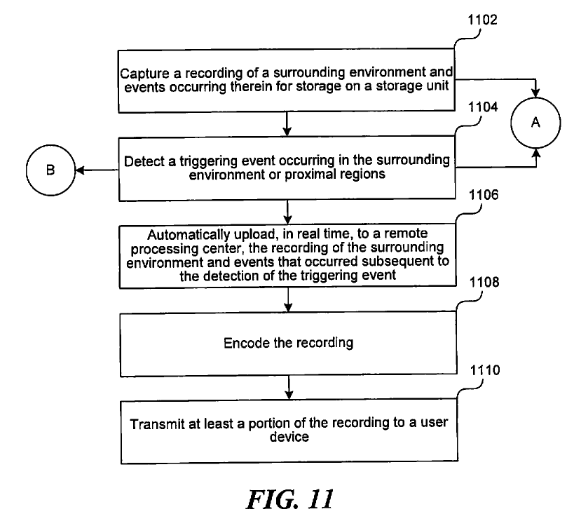

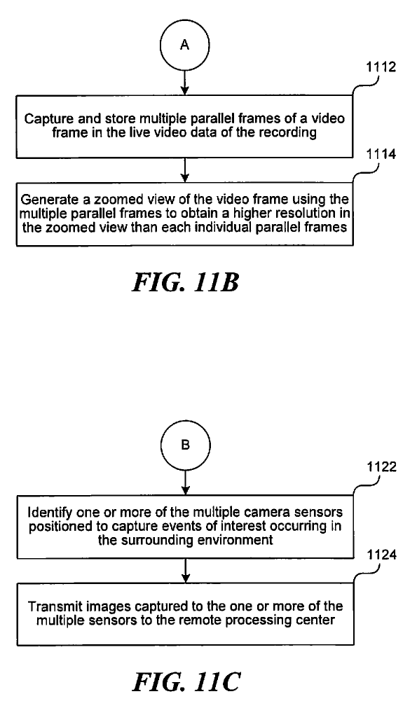

FIGS. 11A-C depict flow diagrams illustrating an example process for remote surveillance using surveillance devices networked to a remote processing center and user devices for preview of the recorded information.

In process 1102, a recording of a surrounding environment and events occurring therein is captured for storage on a storage unit. The recording can include live video data and/or live audio data of the surrounding environment and events occurring inside and outside of the vehicle synchronized to the live video data. In one embodiment, the recording also includes a location map (e.g. a GPS map) of where the live video and audio were recorded from. In some instances, multiple parallel video frames can be captured. The process for capturing multiple parallel video frames is illustrated with further reference to the example of FIG. 11B. In process 1112, multiple parallel frames of a video frame in the live video data of the recording are captured and stored. In process 1114, a zoomed view of the video frame using the multiple parallel frames is generated to obtain a higher resolution in the zoomed view than each individual parallel frames.

In process 1104, a triggering event occurring in the surrounding environment or proximal regions is detected. The triggering event may be detected by occurrence of motion, sound, and/or a combination thereof. The detected motion and/or sound can be indicative of an event (e.g., a car crash, an accident, a fire, a gunshot, an explosion, etc.). In some embodiments, the triggering event is manually triggered such as the activation of a panic button, switch, or other types of actuators.

In process 1106, the recording of the surrounding environment and events that occurred subsequent to the detection of the triggering event is automatically uploaded to a remote processing center. This upload can occur in real time or in near real time. In addition, upon detection of the triggering event, the recorded that occurred prior to the occurrence of the trigger can also be uploaded to the processing center. For example, the recording that occurred over a predetermined or selected amount of time prior to the triggering event can be sent to the processing center for analysis and further processing.

In some instances, one or more camera sensor(s) in the surveillance device is positioned to capture the environment/events of interest. The process for using video images captured by one or more suitably positioned camera sensor(s) is illustrated with further reference to the example of FIG. 11C. In process 1122, one or more of the multiple camera sensors positioned to capture events of interest occurring in the surrounding environment are identified. In process 1124, images captured by the one of more of the multiple sensors are transmitted to the remote processing center.

In process 1108, the recording is encoded. The recording may be encoded by the recording devices (e.g., surveillance devices and captured the recording) and stored on local storage in compressed form to conserve storage space and to minimize air-time (transmission time to the processing center). The recording may also be compressed at the processing center.

In one example, the recording is also encrypted. The encryption may be performed by the recording devices and stored locally in encrypted form to prevent unauthorized access and tampering with the recording. In this example, an encryption key may be maintained and/or generated by the processing center and sent from the processing center to the recording devices (e.g., surveillance devices) to perform the encryption.

In addition, the encryption key may be generated and maintained by the recording devices and transmitted to the processing center such that the encrypted recording can be accessed, viewed, and/or further processed by the processing center.

In process 1110, at least a portion the recording is transmitted to a user device. The user device may be operated and/or monitored by an emergency service (e.g., 911, emergency medical service, the fire department, etc.), roadside assistance, and a law enforcement agency (e.g., FBI, highway patrol, state police, local police department, etc.). In the event that the recording is encrypted, the encryption key may also be transmitted to the user device.

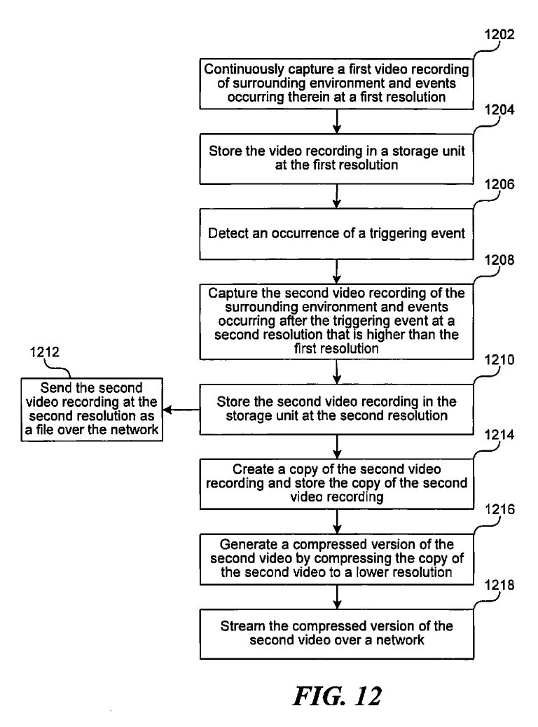

FIG. 12 depicts a flow diagram illustrating an example process for capturing and compressing a video recording captured by a surveillance device.

In process 1202, a first video recording of surrounding environment and events occurring therein are continuously captured at a first resolution. In process 1204, the video recording is stored in a storage unit at the first resolution.

In process 1206, an occurrence of a triggering event is detected. The triggering event can include the activation of a panic button or detection of human activity, for example, by the surveillance device. The detected human activity can include detecting a human that is falling and/or climbing, etc.

In process 1208, the second video recording of the surrounding environment and events occurring after the triggering event is captured at a second resolution that is higher than the first resolution. In process 1210, the second video recording is stored in the storage unit at the second resolution. In process 1212, the second video recording can be sent at the second resolution as a file over the network. The video recording can be sent as a file upon receipt of a request by a user via the host server or another user device to download the recording as file.

In process 1214, a copy of the second video recording is created and stored. In process 1216, a compressed version of the second video is generated by compressing the copy of the second video to a lower resolution. The compression ratio of the second video can be anywhere between 75-90%. In process 1218, the compressed version of the second video is streamed over a network. The compressed version of the second video is transmitted over a cellular network one frame at a time. The compressed video can be streamed over the network in real time or near real time.

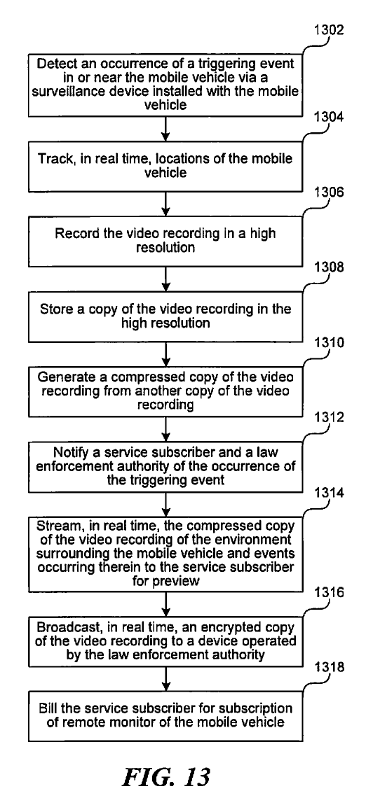

FIG. 13 depicts a flow diagram illustrating an example process for providing subscription services for remotely monitoring a mobile vehicle.

In process 1302, an occurrence of a triggering event in or near the mobile vehicle is detected via a surveillance device installed with the mobile vehicle. Upon occurrence of the triggering event, data including a live recording of an environment surrounding the mobile vehicle and events occurring therein is received. The live recording that is received may be compressed and can include a video recording and an audio recording. In one embodiment, the service subscriber is charged for the surveillance device. In process 1304, locations of the mobile vehicle are tracked in real time.

In process 1306, the video recording is recorded in a high resolution, for example, upon detection of occurrence of the triggering event. Note that the triggering events may be different for different applications but can include a shock, an above threshold acceleration or speed of the vehicle, and/or a crash. In some instances, the triggering event is the activation of a panic button on the monitoring surveillance device of the mobile vehicle.

In process 1308, a copy of the video recording is stored in the high resolution. The video recording in the high resolution can be transmitted as a file in response to a request by users (e.g., the service subscriber). In process 1310, a compressed copy of the video recording is generated from another copy of the video recording.

In process 1312, a service subscriber and a law enforcement authority are notified of the occurrence of the triggering event. In process 1314, the compressed copy of the video recording of the environment surrounding the mobile vehicle and events occurring therein is streamed, in real time, to the service subscriber for preview. In process 1316, an encrypted copy of the video recording is broadcasted, in real time, to a device operated by the law enforcement authority. The live recording can be encrypted using a government-approved (e.g., NSA approved) encryption algorithm. In process 1318, the service subscriber is billed for subscription of remote monitor of the mobile vehicle, for example, on a monthly basis or yearly basis.

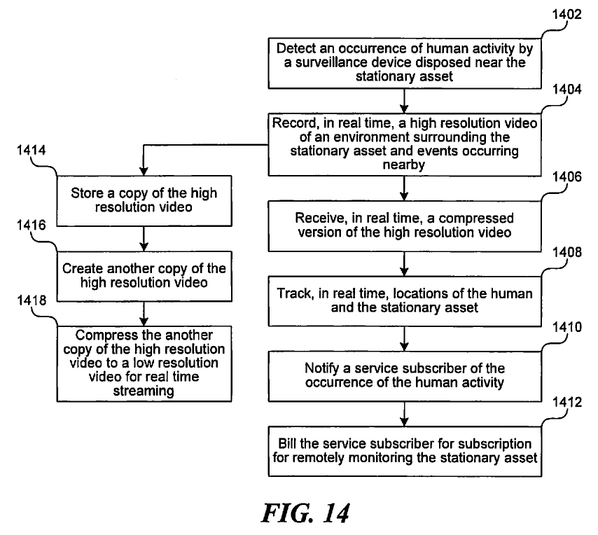

FIG. 14 depicts a flow diagram illustrating an example process for providing subscription services for remotely monitoring stationary assets.

In process 1402, an occurrence of human activity is detected by a surveillance device disposed near the stationary asset. In process 1404, a high resolution video of an environment surrounding the stationary asset and events occurring nearby is recorded. The high resolution video can be recorded in real time or near real time. In addition, an audio recording of the environment surrounding the stationary asset and the events occurring nearby can be recorded in real time or near real time. In process 1406, a compressed version of the high resolution video is received in real time.

In process 1408, locations of the human and the stationary asset are tracked, for example, in real time or near real time. In process 1410, a service subscriber is notified of the occurrence of the human activity. In some embodiments, human presence can be detected in addition to or in lieu of human activity. In process 1412, the service subscriber is billed for subscription for remotely monitoring the stationary asset.

In process 1414, a copy of the high resolution video is stored. In process 1416, another copy of the high resolution video is created. In process 1418, another copy of the high resolution video is compressed to a low resolution video. The low resolution video may be suitable for real time streaming. For example, the low resolution video can be broadcast to the service subscriber over a cellular network for preview. In addition, the high resolution video can be sent as a file over the cellular network to the service subscriber for review.

In one embodiment, law enforcement authorities are notified in response to the detection of the human activity. In addition, the low resolution video can be broadcast to devices operated by the law enforcement authorities over a cellular network for preview. In one embodiment, the low resolution video broadcasted to the devices is encrypted using an National Security Agency approved encryption algorithm.

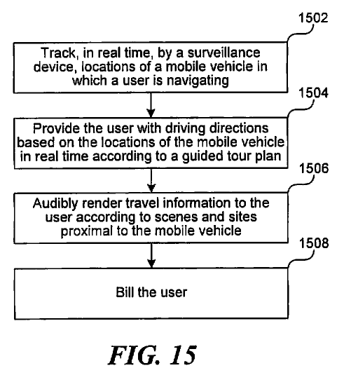

FIG. 15 depicts a flow diagram illustrating an example process for providing subscription services for remotely providing travel guidance.

In process 1502, locations of a mobile vehicle in which a user is navigating are tracked in real time or near real time by a surveillance device. In process 1504, the user is provided with driving directions based on the locations of the mobile vehicle in real time according to a guided tour plan. In one embodiment, the system provides multiple guided tour plans from which the user selects to download to the surveillance device, for example, over the Internet. In process 1506 travel information is audibly rendered to the user according to scenes and sites proximal to the mobile vehicle. In process 1508, the user is billed.

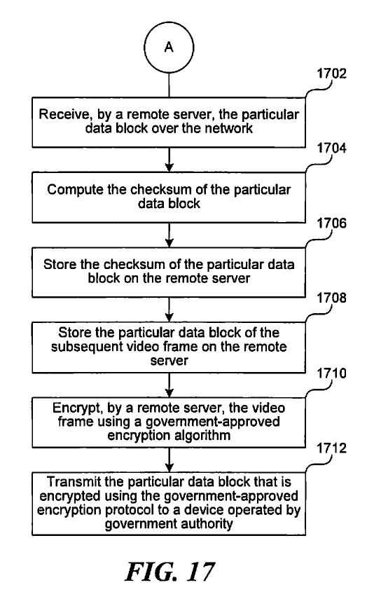

FIGS. 16-17 depict flow diagrams illustrating an example process for protecting data security and optimizing bandwidth for transmission of video frames.

In process 1602, a video frame is captured. In one embodiment, the video frame is captured using a surveillance device and the video frame can include a recording of environment surrounding the surveillance device and events occurring therein. The video frame can include a first set of data blocks each corresponding to non-overlapping pixel locations in the video frame.

In process 1620, it is determined whether the video frame is the first frame of a series of video frames. If so, in process 1622, each of the first set of data blocks are transmitted over the network.

In process 1604, a first set of checksum values is computed for each of the first set of data blocks. In process 1606, the first set of checksum values of each of the first set of data blocks are stored in a computer-readable storage medium.

In process 1608, a subsequent video frame is captured. The subsequent video frame can include a second set of data blocks. In general, each of second set of data blocks corresponds to non-overlapping pixel locations in the subsequent video frame that are same as the non-overlapping pixel locations in the video frame that correspond to the first set of data blocks.

In process 1610, a second set of checksum values are computed for each of the second set of data blocks. In process 1612, a checksum value of the second set of checksum values for a particular data block in the second set of data blocks is compared with a stored checksum value for a data block in the first set of data blocks. The data blocks that are compared among the first and second sets typically correspond in pixel location with the particular data block.

In process 1614, it is determined whether the checksum value of the particular data block is equal to the stored checksum value. In process 1616, the particular data block of the second set of data blocks is transmitted over the network. In process 1618, the second set of checksum values are stored in the computer-readable storage medium.

In process 1702, the particular data block are received over the network by a remote server. In process 1704, the checksum of the particular data block is computed. In process 1706, the checksum of the particular data block is stored on the remote server. In process 1708, the particular data block of the subsequent video frame is stored on the remote server. In one embodiment, the video frame and the subsequent video frame are encoded using MPEG4-AVC.

In process 1710, the video frame is encrypted, by the remote server, using a government-approved encryption algorithm. In process 1712, the particular data block that is encrypted using the government-approved encryption protocol is transmitted to a device operated by government authority.

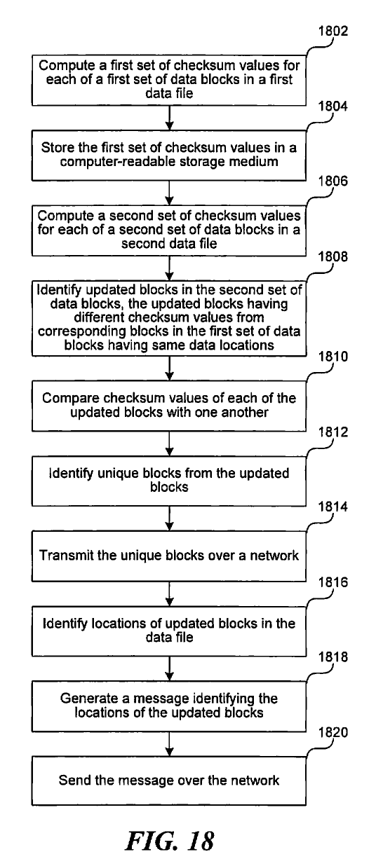

FIG. 18 depicts a flow diagram illustrating an example process for protecting data security and optimizing bandwidth for transmission of data blocks in a data file.

In process 1802, a first set of checksum values is computed for each of a first set of data blocks in a first data file. In general, each of the first set of data blocks corresponds to non-overlapping data locations in the first data file.

In process 1804, the first set of checksum values are stored in a computer-readable storage medium.

In process 1806, a second set of checksum values are computed for each of a second set of data blocks in a second data file. Each of second set of data blocks generally corresponds to non-overlapping data locations in the second data file that are same as the non-overlapping data locations in the first data file that correspond to the first set of data blocks.

In process 1808, updated blocks in the second set of data blocks are identified. In general, the updated blocks have different checksum values from corresponding blocks in the first set of data blocks having same data locations. In process 1810, checksum values of each of the updated blocks are compared with one another.

In process 1812, unique blocks are identified from the updated blocks. In process 1814, the unique blocks are transmitted over a network. In process 1816, locations of updated blocks in the data file are identified. In process 1818, a message identifying the locations of the updated blocks is generated. In process 1820, the message is sent over the network.

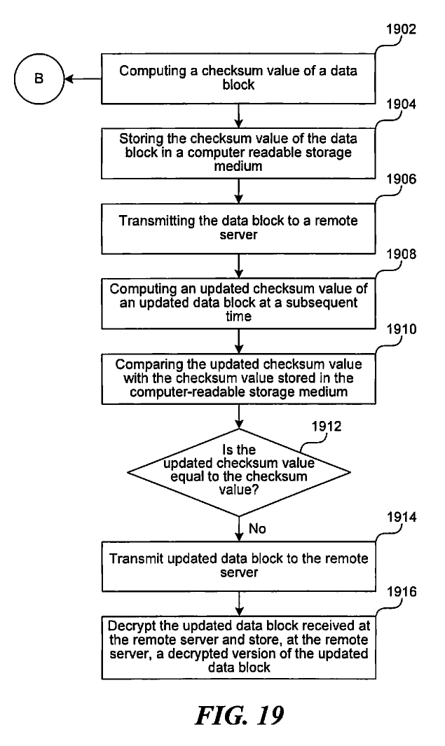

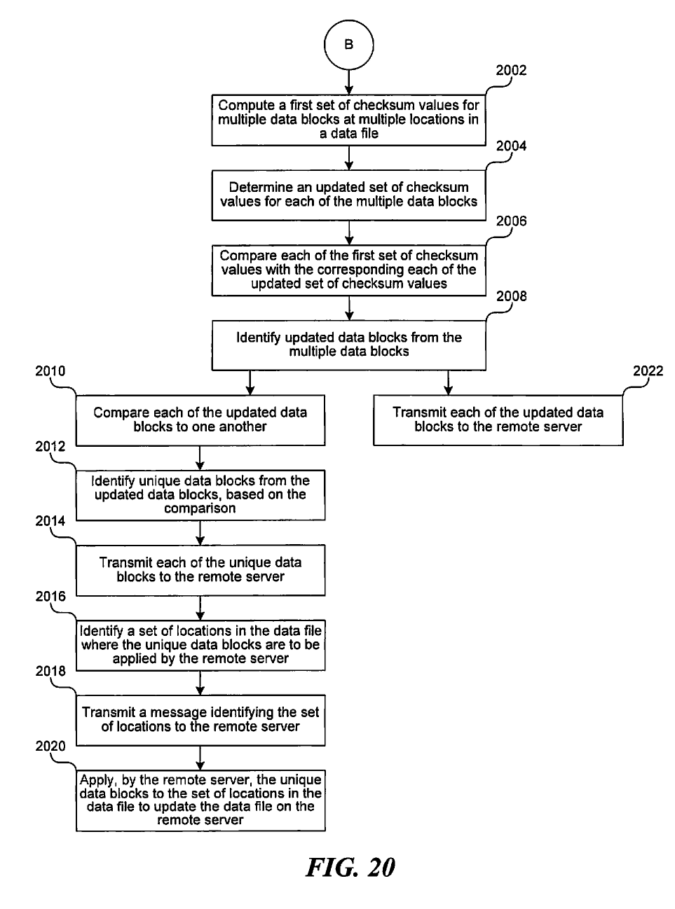

FIGS. 19-20 depict flow diagrams illustrating another example process for optimizing bandwidth for transmission of data blocks in a data file.

In process 1902, a checksum value of a data block is computed. The data block for which the checksum value is computed may be encrypted or un-encrypted. In one embodiment, the checksum value is computed from an encrypted version of the data block.

In process 1904, the checksum value of the data block is stored in a computer readable storage medium. In process 1906, the data block is transmitted to a remote server.

In process 1908, an updated checksum value of an updated data block is computed at a subsequent time. In process 1910, the updated checksum value is compared with the checksum value stored in the computer-readable storage medium. In process 1912, it is determined whether the updated checksum value is equal to the checksum value. If not, in process 1914, updated data block is transmitted to the remote server.

In process 1916, the updated data block received at the remote server decrypted. The decrypted version of the updated data block can also be stored at the remote server. In one embodiment, the updated data block is encrypted at the remote server using a government-approved encryption algorithm. The encrypted data block can then be transmitted to a device operated by government authority.

In process 2002, a first set of checksum values is computed for multiple data blocks at multiple locations in a data file. In process 2004, an updated set of checksum values is determined for each of the multiple data blocks. In process 2006, each of the first set of checksum values is compared with the corresponding each of the updated set of checksum values. In process 2008, updated data blocks are identified from the multiple data blocks. In generally, each of the updated data blocks have an updated checksum value that does not equal each of the corresponding checksums of the first set of checksum values.

In process 2010, each of the updated data blocks are compared to one another. In process 2012, unique data blocks are identified from the updated data blocks, based on the comparison. In process 2014, each of the unique data blocks are transmitted to the remote server. In process 2016, a set of locations in the data file where the unique data blocks are to be applied by the remote server are identified.

In process 2018, a message identifying the set of locations is transmitted to the remote server. In process 2020, the unique data blocks are applied by the remote server to the set of locations in the data file to update the data file on the remote server. In process 2022, each of the updated data blocks are transmitted to the remote server. The remote server can compute the unique checksum values of the each of the unique data blocks and store the unique checksum values.

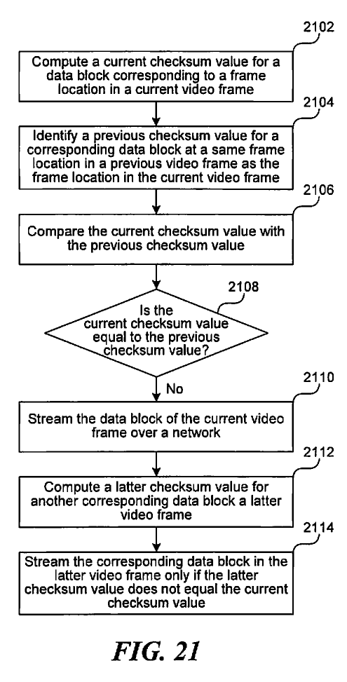

FIG. 21 depicts a flow diagram illustrating an example process for optimizing bandwidth for streaming video over a network.

In process 2102, a current checksum value is computed for a data block corresponding to a frame location in a current video frame. In process 2104, a previous checksum value is identified for a corresponding data block at a same frame location in a previous video frame as the frame location in the current video frame. In process 2106, the current checksum value is compared with the previous checksum value.

In process 2108, it is determined whether the current checksum value is equal to the previous checksum value. In process 2110, the data block of the current video frame is streamed over a network. In process 2112, a latter checksum value is computed for another corresponding data block a latter video frame. The corresponding data block generally corresponds in frame location to the data block in the current video frame. In process 2114, the corresponding data block in the latter video frame is streamed only if the latter checksum value does not equal the current checksum value.

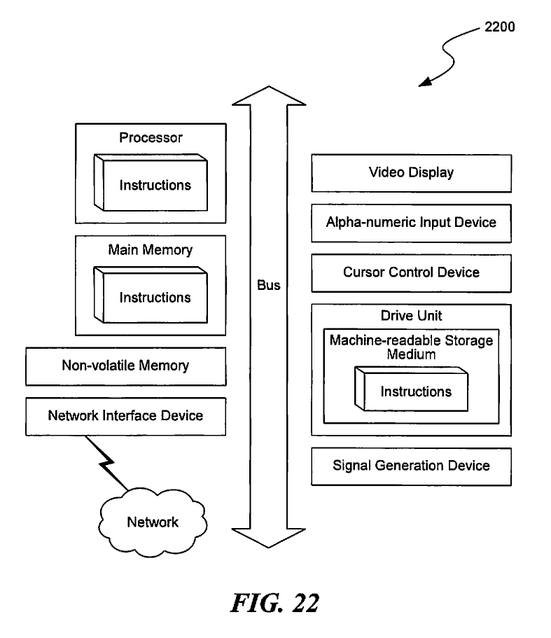

FIG. 22 shows a diagrammatic representation of a machine in the example form of a computer system 2200 within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method for remotely monitoring a mobile vehicle, the method, comprising:
detecting an occurrence of a triggering event in or near the mobile vehicle via a surveillance device installed with the mobile vehicle;
upon the occurrence of the triggering event, receiving, in real time, data including a live recording of an environment surrounding the mobile vehicle and events occurring therein;
tracking, in real time, locations of the mobile vehicle;
notifying a service subscriber of the occurrence of the triggering event; and
billing the service subscriber for subscription of remote monitoring of the mobile vehicle.

2. The method of claim 1, further comprising, charging the service subscriber for the surveillance device.

3. The method of claim 1, wherein, the service subscriber is billed monthly for the subscription.

4. The method of claim 1, further comprising, sending, in real time, the live recording of the environment surrounding the mobile vehicle and events occurring therein to the service subscriber for preview.

5. The method of claim 1, wherein, the data including the live recording received in real time is compressed.

6. The method of claim 5, wherein, the live recording includes a video recording and an audio recording.

7. The method of claim 5, further comprising,
upon detecting the occurrence of the triggering event, recording the video recording in a high resolution;
storing a copy of the video recording in the high resolution;
creating another copy of the video recording; and
compressing the another copy of the video recording for real time streaming.

8. The method of claim 7, further comprising, transmitting the video recording in the high resolution as a file in response to a request by the service subscriber.

9. The method of claim 1, further comprising, notifying a law enforcement authority in response to detection of the triggering event.

10. The method of claim 9, further comprising:
encrypting the live recording using a government-approved encryption algorithm; and
broadcasting the live recording to a device operated by the law enforcement authority.

11. The method of claim 1, wherein, the triggering event is an above threshold acceleration.

12. The method of claim 1, wherein, the triggering event is a shock.

13. The method of claim 1, wherein, the triggering event is a crash.

14. The method of claim 1, wherein, the triggering event is an activation of a panic button on the surveillance device.

15. A method for remotely monitoring a stationary asset, the method, comprising:
detecting an occurrence of human activity via a surveillance device disposed near the stationary asset;
recording, in real time, a high resolution video of an environment surrounding the stationary asset and events occurring nearby, upon the occurrence of the human activity;
receiving, in real time, a compressed version of the high resolution video;
tracking, in real time, locations of the human and the stationary asset;
notifying a service subscriber of the occurrence of the human activity; and
billing the service subscriber for subscription for remotely monitoring the stationary asset.

16. The method of claim 15, further comprising,
storing a copy of the high resolution video;
creating another copy of the high resolution video; and
compressing the another copy of the high resolution video to a low resolution video for real time streaming.

17. The method of claim 11, further comprising, recording, in real time, an audio recording of the environment surrounding the stationary asset and the events occurring nearby.

18. The method of claim 16, further comprising, broadcasting, in real time, the low resolution video to the service subscriber over a cellular network for preview.

19. The method of claim 15, further comprising, sending, the high resolution video as a file over the cellular network to the service subscriber for review.

20. The method of claim 15, further comprising,
notifying law enforcement authorities in response to the detection of the human activity; and
broadcasting, in real time, the low resolution video to devices operated by the law enforcement authorities over a cellular network for preview.

21. The method of claim 20, wherein, the low resolution video broadcasted to the devices is encrypted using an National Security Agency approved encryption algorithm.

22. A method for remotely providing travel guidance, the method, comprising:
tracking, in real time, by a surveillance device, locations of a mobile vehicle in which a user is navigating;
according to a guided tour plan, providing the user with driving directions based on the locations of the mobile vehicle in real time;
audibly rendering travel information to the user according to scenes and sites proximal to the mobile vehicle;
billing the user for subscription for remotely providing the travel guidance.

23. The method of claim 22, wherein, the guided tour plan is downloaded to the surveillance device by the user over the Internet.

24. The method of claim 22, further comprising, providing multiple guided tour plans from which the user selects to download to the surveillance device.

25. A machine-readable storage medium having stored thereon a set of instructions which when executed perform for remotely monitoring a mobile vehicle, the method, comprising:
detecting an occurrence of a triggering event in or near the mobile vehicle via a surveillance device installed with the mobile vehicle;
tracking, in real time, locations of the mobile vehicle;
recording the video recording in a high resolution;
storing a copy of the video recording in the high resolution;
creating another copy of the video recording;
generating a compressed copy of the video recording from the another copy of the video recording;
notifying a service subscriber and a law enforcement authority of the occurrence of the triggering event;
streaming, in real time, the compressed copy of the video recording of the environment surrounding the mobile vehicle and events occurring therein to the service subscriber for preview;
broadcasting, in real time, an encrypted copy of the video recording to a device operated by the law enforcement authority;
billing the service subscriber for subscription of remote monitor of the mobile vehicle.

26. A system for remotely monitoring a stationary asset, the system, comprising:
a surveillance device disposed near the stationary asset that detects an occurrence of human activity;
wherein, the surveillance device records, in real time, a high resolution video of an environment surrounding the stationary asset and events occurring nearby, upon the occurrence of the human activity;
a host server that receives, in real time, a compressed version of the high resolution video and tracks, in real time, locations of the human and the stationary asset;
wherein, the host server includes an alert module that notifies a service subscriber of the occurrence of the human activity; and
wherein, the host server includes a billing module that bills the service subscriber for subscription for remotely monitoring the stationary asset.
